(19) United States
(12) Patent Application Publication
(10) Pub. No.: US 2020/0213270 A1
(43) Pub. Date: Jul. 2, 2020

(54) LOCALLY ADMINISTERED ADDRESSING IN A NETWORK

(71) Applicant: QUALCOMM Incorporated, San Diego, CA (US)

(72) Inventors: Maarten Menzo Wentink, Nijmegen (NL); Jouni Kalevi Malinen, Tuusula (FI)

(21) Appl. No.: 16/723,504

(22) Filed: Dec. 20, 2019

Related U.S. Application Data
(60) Provisional application No. 62/787,713, filed on Jan. 2, 2019.

(51) Int. Cl. H04L 29/12; H04L 12/855

(52) U.S. Cl. CPC H04L 61/2046; H04L 61/2061; H04L 61/6022; H04L 61/2038; H04L 47/2466

(57) ABSTRACT

This disclosure provides systems, methods, and apparatus, including computer programs encoded on computer-readable media, for using a locally administered address (LAA) on a network. In some aspects, a candidate address from an LAA range may be selected by either a first apparatus (such as a wireless station, STA) or a network apparatus (such as an access point, AP). A candidate address test may be performed by the STA or AP to determine if another apparatus is using the candidate network address on a communication medium. An extended address test may be used to determine if the candidate network address is being used by another apparatus in a layer two (data link layer) domain of a network. Several techniques for changing an LAA are provided, including techniques that use a fast session transfer (FST) procedure. In a peer-to-peer network, address changes may be handled using tunneled address change messages.

### CROSS-REFERENCE TO RELATED APPLICATIONS

This patent application claims priority to U.S. Provisional Patent Application No. 62/787,713, filed Jan. 2, 2019, entitled “LOCALLY ADMINISTERED ADDRESSING IN A NETWORK,” and assigned to the assignee hereof. The disclosure of the prior application is considered part of and is incorporated by reference in this patent application.

### TECHNICAL FIELD

This disclosure relates to the field of network communication, and more particularly to local administered addressing in a network.

### DESCRIPTION OF THE RELATED TECHNOLOGY

A network, such as a wireless local area network (WLAN), enables associated apparatuses to communicate with each other via a communication medium. A media access control address (MAC address) of an apparatus is a unique identifier assigned to a network interface of the apparatus for use in the data link layer of a network segment. MAC addresses also may be used as a network address of the apparatus in the WLAN. A MAC address may be either be universally administered addresses (UAA) or locally administered addresses (LAA). Typically, a universally administered address is assigned to an apparatus by its manufacturer from a pool of addresses globally reserved for use by the manufacturer. Each apparatus may have a unique universally administered address. Because universally administered addresses are unique, it is possible to monitor or track an apparatus using the universally administered address.

To enhance privacy, some manufacturers enable an apparatus to use a random MAC address rather than the universally administered address. The random MAC address may be selected from a locally administered address range reserved by the Institute of Electrical and Electronic Engineers (IEEE) standards association. However, as more apparatuses use addresses from the locally administered address range, there is a potential for address collisions to occur.

### SUMMARY

The systems, methods, and devices of this disclosure each have several innovative aspects, no single one of which is solely responsible for the desirable attributes disclosed herein.

One innovative aspect of the subject matter described in this disclosure can be implemented as a method performed by a wireless local area network (WLAN) apparatus. The method may include determining, by the first apparatus, a first candidate network address from at least a first locally administered address range. The method may include performing at least one iteration of a candidate address test that includes outputting a first transmission having the first candidate network address via a communication medium and monitoring for a second transmission that is a response to the first transmission. The method may include determining whether a second apparatus is using the first candidate network address on the communication medium based, at least in part, on whether the first apparatus detects the second transmission from the second apparatus.

In some implementations, the method may include determining that the first candidate network address is available for use by the first apparatus if the first apparatus does not detect the second transmission during a time period following the first transmission. The method may include using the first candidate network address as a locally administered media access control (MAC) address of the first apparatus in a network.

In some implementations, the method may include determining that the first candidate network address is unavailable for use by the first apparatus if the first apparatus does detect the second transmission during a time period following the first transmission. The method may include determining, by the first apparatus, a second candidate network address from the first locally administered address range. The method may include performing a second iteration of the candidate address test using the second candidate network address instead of the first candidate network address.

In some implementations, the first transmission may indicate the first candidate network address as a receiver address and the first transmission may indicate a predefined globally-reserved address as a transmitter address.

In some implementations, the predefined globally-reserved address may be specified by a technical standard.

In some implementations, the predefined globally-reserved address may be a MAC address of a network apparatus that has been rendered inoperable such that the predefined globally-reserved address is reserved for apparatuses performing the candidate address test.

In some implementations, the first transmission may include either a quality of service (QoS) Null frame or a non-QoS Null frame.

In some implementations, the second transmission may include an acknowledgement (ACK) frame that the second apparatus is configured to send in response to the QoS Null frame or non-QoS Null frame.

In some implementations, the second apparatus may be required by a technical standard to send the ACK frame regardless of a basic service set identifier (BSSID) and a network allocation vector (NAV) setting of a network.

In some implementations, the first transmission may include a QoS Null frame that includes a receiver address field, a transmitter address field, and a test address field. The receiver address field may indicate the first candidate network address. The transmitter address field may indicate either the first candidate network address, a predefined globally-reserved address, a random address selected from the first locally administered address range, or a temporary address from a reserved address range. The test address field may indicate either the first candidate network address, the predefined globally-reserved address, the random address, or the temporary address.

In some implementations, the transmitter address field and the test address field may include different ones of the first candidate network address, the predefined globally-reserved address, the random address, or the temporary address.

In some implementations, the method may include performing multiple iterations of the candidate address test. The method may include determining that the first candidate network address is available for use by the first apparatus if the first apparatus does not receive any responses during any of the multiple iterations of the candidate address test.

In some implementations, the first transmission may include a clear to send (CTS) frame, a QoS Null frame, or a Non-QoS Null frame. The method may include, before outputting the first transmission, synchronizing a network allocation vector (NAV) associated with the communication medium. The NAV may be a virtual carrier-sense mechanism used by multiple apparatuses on the communication medium.

In some implementations, synchronizing the NAV may include monitoring the communication medium for a time period and determining that the communication medium is idle during the time period.

In some implementations, synchronizing the NAV may include receiving a management frame via the communication medium. The management frame may include a NAV setting used to synchronize the NAV.

In some implementations, synchronizing the NAV may include detecting a contention-based access of the communication medium by another apparatus and setting the NAV based on a time period associated with the contention-based access.

In some implementations, the method may include using the first candidate network address as a locally administered media access control (MAC) address of the first apparatus on the communication medium. The method may include, after a period of absence during which the first apparatus is not monitoring the communication medium, performing another iteration of the candidate address test to verify that the first candidate network address remains available for use by the first apparatus.

In some implementations, the method may include performing another iteration of the candidate address test after each time the first apparatus returns to the communication medium following another period of absence.

In some implementations, the period of absence may be associated with at least one member selected from a group consisting of a power save mode, a channel scanning operation, a discovery operation, and a channel switch.

In some implementations, the method may include determining that no other apparatus is using the first candidate network address on the communication medium if the first apparatus does not detect the second transmission during a time period following the first transmission. The method may include performing an extended address test to determine whether the first candidate network address is used by another apparatus on another communication medium associated with a network.

In some implementations, the extended address test may be used to determine whether another apparatus is using the first candidate network address within a data link layer domain of the network.

In some implementations, the network may include an extended service set (ESS) with one or more basic service sets (BSSs). The extended address test may be used to determine whether another apparatus is using the first candidate network address within the ESS.

In some implementations, performing the extended address test may include sending an association request to an access point (AP) of the network. The association request may include the first candidate network address and an indicator that the first candidate network address is a new locally administered media access control (MAC) address of the first apparatus.

In some implementations, the extended address test may further include receiving an association response from the AP indicating that the first candidate network address is available for the first apparatus to use in the network.

In some implementations, the association response from the AP may be based, at least in part, on results of a data link layer test performed by the AP.

In some implementations, the association response from the AP may be based, at least in part, on whether the first candidate network address is included in a database for maintaining a list of locally administered addresses used by apparatuses in the network.

In some implementations, the extended address test may further include receiving a management frame from the AP in response to the association request. The management frame may indicate that the first candidate network address is unavailable for the first apparatus to use in the network. The method may include determining a second candidate network address from the first locally administered address range and performing another iteration of the candidate address test using the second candidate network address instead of the first candidate network address.

In some implementations, the method may include determining that the first candidate network address is available for use by the first apparatus if the first apparatus does not detect the second transmission during a time period following the first transmission. The method may include using the first candidate network address as a locally administered media access control (MAC) address of the first apparatus in a network. The method may include subsequently receiving a management frame from a network apparatus indicating that the network apparatus has detected another apparatus using the first candidate network address in the network. The method may include determining a second candidate network address from the first locally administered address range and performing another iteration of the candidate address test using the second candidate network address instead of the first candidate network address.

In some implementations, the method may include using a token-based fast session transfer (FST) procedure to change from the first candidate network address to the second candidate network address without performing a new association with the network apparatus.

In some implementations, the method may include determining, by the first apparatus, a second candidate network address from the first locally administered address range. The method may include using the first candidate network address as a primary address of the first apparatus and the second candidate network address as a secondary address of the first apparatus.

In some implementations, the method may include, before using the second candidate network address as the secondary address, performing an iteration of the candidate address test using the second candidate network address to determine that no other apparatus is using the second candidate network address on the communication medium.

In some implementations, the first apparatus may be configured to interchangeably use both the primary address and the secondary address for communication with a network.

In some implementations, the first apparatus may be configured to use the secondary address only when another apparatus is detected using the primary address for communication with the network.

In some implementations, the first apparatus may be configured to periodically perform iterations of the candidate address test to verify that no other apparatus is using either the primary address or the secondary address of the first apparatus.

In some implementations, the method may include determining that another apparatus is using the secondary address. The method may include determining a new candidate network address to be used as a new secondary address. The method may include using the primary address to inform an access point about the new secondary address.

In some implementations, the method may include, after using the primary address on a network, determining that another apparatus is using the primary address. The method may include switching to the secondary address for subsequent communication with the network.

In some implementations, the method may include upgrading the secondary address to the primary address and determining a new candidate network address to be used as the secondary address.

In some implementations, the method may include determining a new candidate network address to be used as a new primary address and using the secondary address to inform an access point about the new primary address.

In some implementations, the method may include receiving a data transmission from an access point. The data transmission may include a message integrity check (MIC) portion derived by the access point using either the primary address or the secondary address. The method may include verifying, by the first apparatus, an integrity of the data transmission using the MIC portion.

In some implementations, verifying the integrity of the data transmission may include determining whether the MIC portion is derived using either the primary address or the secondary address.

In some implementations, the method may include maintaining a security association with the access point regardless of whether the primary address or the secondary address are used for the security association.

In some implementations, the method may include sending a candidate address check request frame to an access point of a network. The candidate address check request frame may include a list of candidate network addresses. The method may include receiving a candidate address check response frame from the access point indicating at least one selected address from among the list of candidate network addresses.

In some implementations, the method may include using at least one selected address from among the list of candidate network addresses as a primary address of the first apparatus on the network.

In some implementations, the method may include performing and iteration of the candidate address test to verify that no other apparatus is using the primary address.

In some implementations, sending the candidate address check request frame may include the first apparatus using the first candidate network address as a transmitting address in the candidate address check request frame.

In some implementations, the first candidate network address may be included in the list of candidate network addresses.

In some implementations, the candidate address check response frame from the access point may include those addresses from among the list of candidate network addresses that are not being used by any other apparatuses in a data link layer domain of the network.

Another innovative aspect of the subject matter described in this disclosure can be implemented as a method for network communication by a first apparatus. The method may include determining, by the first apparatus, a list of candidate network addresses from at least a first locally administered address range. The method may include sending a candidate address check request frame to an access point of a network. The candidate address check request frame may include the list of candidate network addresses. The method may include receiving a candidate address check response frame from the access point indicating at least a first selected address from among the list of candidate network addresses for the first apparatus to use on the network.

In some implementations, the method may include using the first selected address as a primary address of the first apparatus on the network.

In some implementations, the method may include, before using the first selected address as the primary address of the first apparatus, performing a candidate address test to verify that no other apparatus is using the first selected address.

In some implementations, sending the candidate address check request frame may include using a temporary address as a transmitting address of the first apparatus in the candidate address check request frame.

In some implementations, the temporary address may be included in the list of candidate network addresses.

In some implementations, the temporary address may be a randomly selected addressed from a reserved pool of temporary addresses different from the first locally administered address range.

In some implementations, the candidate address check response frame from the access point may include those addresses from among the list of candidate network addresses that are not being used by any other apparatuses in a data link layer domain of the network.

In some implementations, the method may include using the first selected address as a primary address of the first apparatus on the network and using a second selected address from the candidate address check response frame as a secondary address of the first apparatus on the network.

In some implementations, the method may include sending a message to the access point to indicate that the primary address and the secondary address use a same security association between the first apparatus and the access point.

Another innovative aspect of the subject matter described in this disclosure can be implemented as a method for network communication by an access point of a network. The method may include receiving a candidate address check request frame from a first apparatus. The candidate address check request frame may include a list of candidate network addresses from at least a first locally administered address range. The method may include sending a candidate address check response frame from the access point to the first apparatus, the candidate address check response frame indicating at least a first selected address from among the list of candidate network addresses for the first apparatus to use on the network.

In some implementations, the method may include, for at least the first selected address, performing, by the access point, a candidate address test to verify that no other apparatus is using the first selected address. The candidate address test may include outputting a first transmission having the first selected address via a communication medium and monitoring for a second transmission that is a response to the first transmission. The method may include determining that no other apparatus is using the first selected address on the communication medium if the access point does not detect the second transmission during a time period following the first transmission.

In some implementations, the method may include performing an extended address test to determine whether the first selected address is used by another apparatus on another communication medium associated with the network.

In some implementations, the extended address test may be used to determine whether another apparatus is using the first selected address within a data link layer domain of the network.

In some implementations, the network includes an extended service set (ESS) with one or more basic service sets (BSSs), and where the extended address test is used to determine whether another apparatus is using the first selected address within the ESS.

In some implementations, the method may include receiving an association request from the first apparatus using the first selected address. The association request may include an indicator that the first selected address is a new address of the first apparatus in the network. The extended address test is performed in response to receiving the association request with the indicator.

In some implementations, the method may include sending an association response to the first apparatus based, at least in part, on results of a data link layer test performed by the access point.

Another innovative aspect of the subject matter described in this disclosure can be implemented as a method for network communication by an access point of a network. The method may include determining, by the access point, a first candidate network address from at least a first locally administered address range. The method may include sending the first candidate network address to a first apparatus for the first apparatus to use on the network.

In some implementations, the method may include, before sending the first candidate network address to the first apparatus, performing at least one iteration of a candidate address test that includes outputting a first transmission having the first candidate network address via a communication medium and monitoring for a second transmission that is a response to the first transmission. The method may include determining whether a second apparatus is using the first candidate network address on the communication medium based, at least in part, on whether the first apparatus detects the second transmission from the second apparatus.

In some implementations, the method may include, before sending the first candidate network address to the first apparatus, performing an extended address test to determine whether the first candidate network address is used by another apparatus on another communication medium associated with the network.

The method may include the extended address test may be used to determine whether another apparatus is using the first candidate network address within a data link layer domain of the network.

In some implementations, the method may include receiving an address request frame from the first apparatus. The method may include sending an address response frame in response to the address request frame.

In some implementations, the address request frame may include a temporary address of the first apparatus. The address response frame may be sent to the temporary address.

In some implementations, sending the first candidate network address may include sending a list of candidate network addresses to the first apparatus, the list of candidate network addresses including the first candidate network address.

In some implementations, the method may include receiving an association request from the first apparatus using the first candidate network address as a transmitter address and determining that the first apparatus is using the first candidate network address as a primary address for the first apparatus on the network.

Another innovative aspect of the subject matter described in this disclosure can be implemented as a method for network communication by a first apparatus. The method may include determining, by the first apparatus, a first candidate network address and a second candidate network address from at least a first locally administered address range. The method may include establishing an association with an access point of the network using the first candidate network address as a primary address of the first apparatus and the second candidate network address as a secondary address of the first apparatus.

In some implementations, the first apparatus may be configured to receive transmissions from the access point interchangeably using either the primary address or the secondary address.

In some implementations, the first apparatus may be configured to receive transmissions from the access point using the primary address until an address collision of the primary address is detected. The secondary address may be used after the address collision is detected.

In some implementations, the method may include determining that the address collision of the primary address has been detected.

In some implementations, determining that the address collision of the primary address has been detected may include receiving a notification from the access point that the access point has detected the address collision.

In some implementations, determining that the address collision of the primary address has been detected may include detecting a transmission from another apparatus using the primary address and sending a notification to the access point that the first apparatus has detected the address collision.

In some implementations, the method may include discontinuing use of the primary address and using the secondary address to communicate with the access point.

In some implementations, the method may include upgrading the secondary address to a new primary address. The method may include determining a new candidate network address to use as a new secondary address. The method may include informing the access point that the new candidate network address is the new secondary address.

In some implementations, the method may include determining a new candidate network address to use as a new primary address and informing the access point that the new candidate network address is the new primary address. The secondary address may be used to inform the access point regarding the new primary address.

In some implementations, the method may include performing a fast session transfer (FST) procedure to change from the primary address to the secondary address.

In some implementations, the FST procedure may include sending an FST message with a pre-arranged token between the first apparatus and the access point.

In some implementations, the method may include establishing the pre-arranged token as part of an FST session setup or secure message exchange.

In some implementations, the FST procedure is used to change the primary address to the secondary address while remaining on a same wireless channel and wireless frequency band.

In some implementations, determining that the address collision of the primary address has been detected may include receiving a notification from the access point that the access point has detected the address collision. The notification may include a pre-arranged token between the first apparatus and the access point.

Another innovative aspect of the subject matter described in this disclosure can be implemented as a method for network communication by an access point of a network. The method may include receiving an association request from a first apparatus, the association request including a first candidate network address and a second candidate network address from at least a first locally administered address range. The method may include establishing an association with the first apparatus using the first candidate network address as a primary address of the first apparatus and the second candidate network address as a secondary address of the first apparatus.

In some implementations, the method may include determining that an address collision of the primary address has been detected on the network.

In some implementations, the method may include at least one of receiving a notification from the first apparatus that the first apparatus has detected the address collision and detecting a transmission from another apparatus using the primary address.

In some implementations, the method may include discontinuing use of the primary address to communicate with the first apparatus. The method may include using the secondary address to communicate with the first apparatus.

In some implementations, the method may include performing a fast session transfer (FST) procedure to change from the primary address to the secondary address.

In some implementations, the FST procedure may include receiving an FST message with a pre-arranged token between the first apparatus and the access point.

In some implementations, the method may include establishing the pre-arranged token as part of an FST session setup or secure message exchange.

In some implementations, the method may include detecting a transmission from another apparatus using the primary address, sending a notification that the access point has detected the address collision. The notification may include a pre-arranged token between the first apparatus and the access point.

Another innovative aspect of the subject matter described in this disclosure can be implemented as a method for network communication by a first apparatus. The method may include determining, by the first apparatus, a first candidate network address from at least a first locally administered address range. The method may include using the first candidate network address as a primary address of the first apparatus for a peer association with a second apparatus via a tunneled direct link setup (TDLS) link tunneled via an access point of a network. The peer association may be between the primary address of the first apparatus and a peer address of the second address.

In some implementations, the method may include determining that an address collision of the primary address has been detected on the network. The method may include determining a second candidate network address from at least the first locally administered address range. The method may include sending a TDLS Address Change Request frame to the second apparatus to change the primary address to the second candidate network address.

In some implementations, the TDLS Address Change Request frame may be tunneled via the peer association to the second apparatus, and where the TDLS Address Change Request frame includes a fast session transfer (FST) message.

In some implementations, the TDLS Address Change Request frame may be inserted in an Ethertype 89-0d frame.

In some implementations, the TDLS Address Change Request frame may include a pre-arranged token between the first apparatus and the second apparatus.

In some implementations, the method may include establishing the pre-arranged token during a peer setup of the peer association.

Another innovative aspect of the subject matter described in this disclosure can be implemented as a method for network communication. The method may include maintaining a database including a list of locally administered addresses used by apparatuses in a network. The method may include receiving a candidate address check request frame indicating at least a first candidate network address. The method may include sending a candidate address check response frame indicating whether the first candidate network address is included in the database.

In some implementations, the database is included in an access point of the network.

Another innovative aspect of the subject matter described in this disclosure can be implemented as an apparatus. The apparatus may include a processor configured to perform any one of the above-mentioned methods.

Another innovative aspect of the subject matter described in this disclosure can be implemented as a computer-readable medium having stored therein instructions which, when executed by a processor, causes the processor to perform any one of the above-mentioned methods.

Another innovative aspect of the subject matter described in this disclosure can be implemented as a system having means for implementing any one of the above-mentioned methods.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram of an example wireless local area network (WLAN) for introducing concepts of this disclosure.

FIG. 2 depicts a message flow diagram showing example messages for a candidate address test procedure to determine if a locally assigned address (LAA) is available.

FIG. 3 depicts a message flow diagram showing example messages for an access point (AP) assisted process for determining a free LAA.

FIG. 4 depicts a message flow diagram showing example messages for an AP to coordinate with a STA to use multiple LAAs.

FIG. 5 depicts a message flow diagram showing example messages for peer relationship in which at least one apparatus is using an LAA.

FIG. 6 depicts a conceptual diagram of an example message for use in an LAA protocol.

FIG. 7 shows a block diagram of an example AP for use in wireless communication.

FIG. 8 shows a block diagram of an example STA for use in wireless communication.

FIG. 9 depicts an example flowchart for a STA performing a candidate address test.

FIG. 10 depicts an example flowchart for a STA to use an AP to assist with selecting an LAA.

FIG. 11 depicts an example flowchart for an AP to assist with selecting an LAA.

FIG. 12 depicts an example flowchart for an AP that assigns an LAA to a STA.

FIG. 13 depicts an example flowchart for a STA using a fast session transfer (FST) procedure with an AP.

FIG. 14 depicts an example flowchart for an AP supporting an FST procedure with a STA.

FIG. 15 depicts an example flowchart for a STA performing an address change with a peer STA.

FIG. 16 depicts an example flowchart for a central resource that supports LAA address collision prevention.

FIG. 17 shows a block diagram of an example apparatus for use in a WLAN device according to some implementations.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving RF signals according to any wireline or wireless communication standard, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, 5G, 6G, or further implementations thereof, technology.

A WLAN in a home, apartment, business, or other area may include one or more WLAN devices. Each WLAN device may have a station (STA) interface (which also may be referred to as a WLAN apparatus) which is an addressable entity that shares a wireless communication medium with other STAs. An access point (AP) is a type of STA that performs a distribution system access function in the WLAN. For brevity in this disclosure, each WLAN device may be referred to as an AP (referring to an AP STA) or a STA (referring to a non-AP STA). Each WLAN device has a network interface (WLAN apparatus) for communicating via a communication medium. A media access control address (MAC address) of an apparatus is a unique identifier assigned to a network interface of the apparatus for use in the data link layer of a network segment. A MAC address may be a universally administered address (UAA) or a locally administered address (LAA). A UAA is a type of MAC address that is globally unique, and which may be assigned to a network interface as part of a manufacturing process. Because MAC addresses are trackable, some WLAN apparatuses may avoid long term identity tracking by using an LAA as a temporary MAC address for the network interface. An LAA is a random address from a locally administered address range. There may be different ranges of addresses reserved for LAAs. However, in this disclosure, the term “locally assigned address range” is intended to include all such ranges that may be reserved by the IEEE for use as an LAA.

Depending on a size of the locally assigned address range and the quantity of WLAN apparatuses using LAAs, there is a potential for an address collision. An address collision refers to the use of a same address by more than one apparatus on a network. In probability theory, the so-called “birthday problem” refers to the phenomenon that in a group of people, the probability that two or more persons have the same birthday is much higher than intuitively expected. For example, the probability that two or more people in a group of 30 people have the same birthday is 70%. The same principle can be observed in randomly selected locally assigned addresses, making the likelihood of address collision likely even for a relatively small network. Current protocols for assigning locally assigned addresses may not be adequate to ensure privacy, uniqueness, and connectivity using a randomly selected LAA within a network. It may be desirable to implement LAA protocols which can provide privacy while also providing seamless failover in the event of an address collision.

Various implementations relate generally to the use of locally assigned addresses within a network. Some implementations more specifically relate to selection, testing, and association using a locally assigned address. A candidate address test may be used to determine whether another apparatus is using the candidate network address on a communication medium. The candidate address test may be performed by a STA or an AP according to various implementations. In some implementations, an extended address test may be used to determine whether the candidate network address is being used by another apparatus in an extended portion (such as a layer 2 domain or an extended service set (ESS)) of a network. This disclosure includes several techniques to coordinate selection of a locally assigned address between a STA and an AP. In some implementations, a primary address and a secondary address may be selected for use by the STA. The STA or the AP may use the secondary address as a failover in the event that the primary address is used by another apparatus. Some implementations of this disclosure relate to a peer-to-peer association between two STAs in which at least one of the STAs is using a locally assigned address.

In some implementations, a candidate address test may use a test transmission to determine if another apparatus is using the candidate network address on the communication medium. For example, a STA may send a short frame, such as a request to send (RTS), a Null frame, or a Quality of service (QoS) Null frame. A communication standard may require a response from any device using an address in those frames. When a response is detected, the STA may determine that the candidate network address is already being used. However, if no response is detected within a time period following the test frame, the STA may determine that the candidate network address might not be used by another apparatus, thus the candidate network address could be available for the STA to use. The STA may perform multiple iterations of the candidate address test before determining that the candidate network address is clear.

As stated above, there may be different types of test frames that could be used for the candidate address test. In some implementations, the type of test frame used may impact the reliability of the test. For example, a second STA may be using the candidate network address but may fail to respond to a RTS if the second STA is offline (such as a power save mode, non-zero network allocation vector (NAV)), or scanning operation on another channel). A network allocation vector (NAV) is a virtual carrier-sensing mechanism used with wireless network protocols such as IEEE 802.11 and IEEE 802.16 (WiMax). The virtual carrier-sensing is a logical abstraction which augments the physical carrier-sensing at the air interface in order to save power. A CTS will not be transmitted when the receiving STA with a matching address has a NAV set (non-zero NAV). Therefore, before sending an RTS as a test frame, a transmitting apparatus (either STA or AP) may ascertain that it is in sync with any NAV being set in its vicinity. As an alternative to the RTS, the transmitting apparatus may send a QoS Null frame. A receiving STA may be required by a technical standard to send an acknowledgement (ACK) frame regardless of a basic service set identifier (BSSID) in the QoS Null frame or a NAV setting at the receiving STA. This disclosure includes several options for address fields which may be included in an RTS, Null, or QoS Null frame.

In some implementations, a first STA that is using an LAA may perform a candidate address test each time the first STA returns from a period of absence. For example, the first STA may be offline from the communication medium due to a power save mode, scanning operation, discovery, or channel switch, among other examples. During that time, a second STA may perform a candidate address test (with the same LAA as the first STA) and begin using the LAA if it did not receive a response from the first STA which was offline. This could result in an address collision when the first STA becomes active. Therefore, in some implementations, each time the first STA resumes listening on a channel after a period of absence, the first STA may perform the candidate address test again to verify that its LAA is still unique on the communication medium.

In some implementations, a network may include more than one communication medium. For example, a layer two domain (also referred to a data link layer) of a communication network may have different network segments on different communication medium. An example of such a network is an extended service set (ESS) which is a collection of APs that share a same Service Set Identifier (SSID) setting. Another example is an Ethernet network that uses switches to connect multiple network segments at a layer two broadcast domain. This disclosure includes several techniques for verifying a candidate network address is unique within a layer two domain. For example, an extended address test may be performed to check whether another apparatus is using the candidate network address in another segment of the network. In some implementations, an AP or centralized resource may maintain a list of locally assigned addresses being used in a network. For example, a STA may send a candidate address check request frame to an AP. The AP may check a database to determine whether the address is being used by another STA. The AP may respond with a candidate address check response frame. In some implementations, the STA may perform a local candidate address test first and then include an indicator in an association request to the AP to indicate that the STA is using an LAA. The AP may perform an extended address test after receiving the association request with the indicator.

In some implementations, a STA may send a list of candidate network addresses to the AP. Alternatively, the AP may send a list of a candidate network addresses to the STA. Selection of the candidate network address for a STA may be from the list transmitted to the AP by the STA. The list may include addresses which are determined to be free (no other apparatuses using them) based on a candidate address test or an extended address test. In some implementations, coordination of the list of candidate network addresses may employ the use of a predefined globally-reserved address or a temporary address. For example, the temporary address may be from a subset of the pool of addresses associated with a locally assigned address range. The predefined globally-reserved address may be set by a technical standard.

In some implementations, a STA may select a primary address and a secondary address from a locally assigned address range. For example, the secondary address may be a backup address for use if an address collision of the primary address is detected. In some implementations, the STA may upgrade the secondary address to the primary address and then select a new secondary address. Alternatively, the STA may communicate using the secondary address while they coordinate to select a new primary address. In some implementations, the primary and the secondary address may be used interchangeably. Once one address becomes unusable because of an address collision, the STA may seamlessly switch to the other address and updates the colliding address with the AP or TDLS peer STA (or peer apparatus).

In secured communications, the MAC address may be used to determine a message integrity check (MIC), which is appended to the frame to check the integrity of the frame at the STA. Since the same security association is used both the primary and the secondary addresses, the STA will be able to ascertain the integrity of frames regardless of whether the primary or secondary address is used.

In some implementations, a MAC address change may be performed using the nontransparent fast session transfer (FST) procedure as described in the draft IEEE 802.11REVmd technical standard. The nontransparent FST procedure may be originally designed to allow fast switching between different bands where different MAC addresses are used in each band. However, in accordance with this disclosure, the FST procedure (or a variation thereof) may be used to change the MAC address (such as from a primary address to a secondary address) while staying on the same channel. An FST session is set up through the FST Setup Request and FST Setup Response frames. Once an FST session is set up, a switch is executed through the FST Ack Request and FST Ack Response frames. However, when an address collision is detected, the current MAC address at the STA may be unusable. Thus, the FST Ack Request and FST Ack Response frames may be replaced with token frames (paging frames). Different tokens are used for FST Ack Request and FST Ack Response. The tokens may be negotiated as part of the FST session setup (using secure frames) or in a separate secure exchange. The token may be large enough to avoid a brute force attack. In some implementations, the AP may detect an address collision for one of its STAs and send an address collision notification frame to the STA to inform the STA of the address collision. The address collision notification frame may be regular protected (secure) frame or a token frame with a token that has been pre-negotiated between the AP and STA. The address collision notification token frame may be transmitted to a predefined address which is the same for all address collision notification frames (and only the token differs).

This disclosure includes some techniques for using a locally assigned address with a peer-to-peer association between two STAs. For example, a Tunneled Direct Link Setup (TDLS) direct link is a direct link between two STAs which is set up using signaling messages that are tunneled through the AP. When one of the TDLS STAs on a TDLS direct link changes its address, this STA may send its new address to the TDLS peer STA using a TDLS Address Change Request frame. The TDLS peer STA responds with a TDLS Address Change Response frame. The TDLS Address Change Request frame and the TDLS Address Change Response frame are newly defined TDLS frames, which are tunneled through the AP like the TDLS setup frames. The TDLS Address Change Request frame and the TDLS Address Change Response frame may be the tunneled variants of the FST Ack Request frame and the FST Ack Response frame when an FST session is used by the TDLS STAs for the address switch. The FST Setup Request and FST Setup Response frames also require tunneled variants in this case. Tunneled variants of the FST Setup Request, FST Setup Response, FST Ack Request, and FST Ack Response frames can be created by inserting the FST Setup Request, FST Setup Response, FST Ack Request, and FST Ack Response Action field, respectively, in an Ethertype 89-0d frame similar to TDLS Action fields inserted in an Ethertype 89-0d frame. The Category subfield of the Action field allows to differentiate between the TDLS Action fields and the FST Action fields.

Another option for TDLS is to use a token frame which replaces the FST Ack Request and FST Ack Response frames. The tokens may be negotiated at the time the FST session is set up between the TDLS peer STAs. The token frame may be transmitted via the direct link. The token frame may be transmitted via the AP by defining a TDLS token frame as a new TDLS frame. A new TDLS Action field may be defined to contain a token. In some implementations, the A3 field (the source address) of the TDLS token frame may be the existing or the new random address of the STA, because the token itself may be used by the TDLS peer STA to identify the FST session to which it pertains (the source address may not be needed in this case).

Particular implementations of the subject matter described in this disclosure can be implemented to realize one or more of the following potential advantages. In some implementations, the described techniques can be used to select a locally assigned address that is unique among apparatuses in a network. The techniques may enable privacy while addressing potential concerns with address collisions that often occur with locally assigned addresses. Furthermore, the techniques in this disclosure may aid with seamless failover in the event that an address collision is detected. The techniques in this disclosure may improve seamless failover capability of a TDLS direct when an address collision is detected. Furthermore, the techniques in this disclosure may aid in discovering an address collision between associated devices on a network or between nearby devices in possibly different networks.

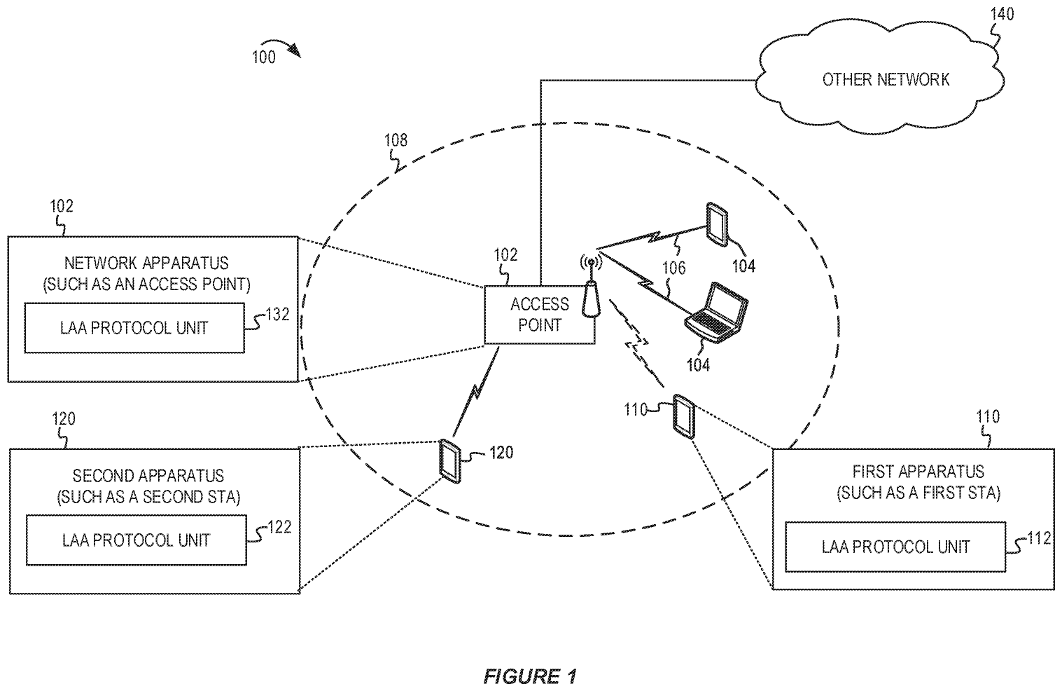

FIG. 1 depicts a system diagram of an example WLAN for introducing concepts of this disclosure. FIG. 1 includes a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an AP 102 and multiple STAs 104 having wireless associations with the AP 102. The IEEE 802.11-2016 specification defines a STA as an addressable unit. An AP is an entity that contains at least one STA and provides access via a wireless medium (WM) for associated STAs to access a distribution service (such as another network 140). Thus, an AP includes a STA and a distribution system access function (DSAF). In the example of FIG. 1, the AP 102 may be connected to a gateway device (not shown) which provides connectivity to the other network 140. The DSAF of the AP 102 may provide access between the STAs 104 and another network 140. While AP 102 is described as an access point using an infrastructure mode, in some implementations, the AP 102 may be a traditional STA which is operating as an AP. For example, the AP 102 may be a STA capable of operating in a peer-to-peer mode or independent mode. In some other examples, the AP 102 may be a software AP (SoftAP) operating on a computer system. The AP may utilize a portion of a frequency band (such as a 2.4 GHz frequency band, a 5 GHz frequency band, etc.) as a communication medium. Within each frequency band, there may be different channels which an AP may utilize as the communication medium. Furthermore, the AP may utilize more than one antenna. For example, an AP may utilize multiple-input-multiple-output (MIMO) communication in which multiple antennas transmit wireless signals.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), wearable devices, music or other audio or stereo devices, remote control devices (“remotes”), printers, kitchen or other household appliances, key fobs (for example, for passive keyless entry and start (PKES) systems), among other possibilities.

The basic building block of a WLAN conforming to the IEEE 802.11 family of standards is a Basic Service Set (BSS), which is managed by an AP. A BSS refers to one STA (such as an AP) that has established service settings and one or more STAs that have successfully synchronized the service settings. Alternatively, a BSS may describe a set of STAs have synchronized matching mesh service profiles. Using the example architecture in FIG. 1, the AP 102 and the associated STAs 104 may be referred to as a basic service set (BSS), which is managed by the AP 102. The BSS may be identified by a service set identifier (SSID) that is advertised by the AP 102. The AP 102 may periodically broadcast beacon frames (“beacons”) to enable any STAs 104 within wireless range of the AP 102 to establish or maintain a respective communication link 106 (also referred to as a “Wi-Fi link” or “wireless association”) with the AP. An “unassociated STA” (not shown) may not be considered part of the BSS because they do not have a wireless session established at the AP 102. The various STAs 104 in the WLAN may be able to communicate with external networks as well as with one another via the AP 102 and respective communication links 106. To establish a communication link 106 with an AP 102, each of the STAs is configured to perform passive or active scanning operations (“scans”) on frequency channels in one or more frequency bands (for example, the 2.4 GHz, 5 GHz, 6 GHz or 60 GHz bands). To perform passive scanning, a STA listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link with the selected AP.

FIG. 1 additionally shows an example coverage area 108 of the AP 102, which may represent a basic service area (BSA) of the WLAN 100. While one AP 102 is shown in FIG. 1, the WLAN 100 can include multiple APs 102. As a result of the increasing ubiquity of wireless networks, a STA 104 may have the opportunity to select one of many BSSs within range of the STA 104 or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104 may function and communicate (via the respective communication links 106) according to the IEEE 802.11 family of standards (such as that defined by the IEEE 802.11-2016 specification or amendments thereof including, but not limited to, 802.11aa, 802.11ah, 802.11aq, 802.11ay, 802.11ax, 802.11az, 802.11ba, and 802.11be). These standards define the WLAN radio and baseband protocols for the physical (PHY) and medium access control (MAC) layers. The APs 102 and STAs 104 transmit and receive frames (hereinafter also referred to as “wireless communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be (which may be referred to as—extremely high throughput (EHT)) standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac, 802.11ax, and 802.11be standard amendments may be transmitted over physical channels having bandwidths of 40 MHz, 80 MHz or 160 MHz by bonding together two or more 20 MHz channels. For example, IEEE 802.11n described the use of 2 channels (for a combined 40 MHz bandwidth) and defined a High Throughput (HT) transmission format. IEEE 802.11ac described the use of 8 channels (for a combined 160 MHz bandwidth) and defined a Very High Throughput (VHT) transmission format. IEEE 802.11ax also supports a combined 160 MHz bandwidth (which is a combination of 8 channels of 20 MHz width each). For brevity, this disclosure includes descriptions of IEEE 802.11ax devices as an example. In IEEE 802.11ax, a transmission format may spread High Efficiency (HE) modulated symbols throughout a combined channel group.

FIG. 1 shows a first apparatus 110 (such as a first STA, similar to the STAs 104) which may be unassociated to the AP 102. A second apparatus (such as a second STA, similar to the STAs 104) may be in the coverage area of the AP 102 and may use a locally assigned address on the communication medium (such as a wireless channel for the BSS managed by the AP 102). The first apparatus 110 may include an LAA protocol unit 112, the second apparatus 120 may include an LAA protocol unit LAA protocol unit 122, and the AP 102 may include an LAA protocol unit 132. The LAA protocol units 112, 122, 132 may implement the LAA protocols described in this disclosure.

For example, the LAA protocol unit 112 of the first apparatus 110 may perform a candidate address test by sending a test message via the communication medium. In some implementations, the first apparatus 110 may be in an unassociated state. In some other implementations, the first apparatus 110 may be associated with AP 102 and may be returning to the communication medium after a period of absence. The candidate address test may indicate a candidate network address selected by the first apparatus 110 from among a locally administered address range. If the second apparatus 120 is using the candidate network address, the LAA protocol unit 122 may be configured to respond to the test message. Alternatively, the AP 102 (using the LAA protocol unit 132) may notify the first apparatus 110 that the candidate network address is already in use in the network.

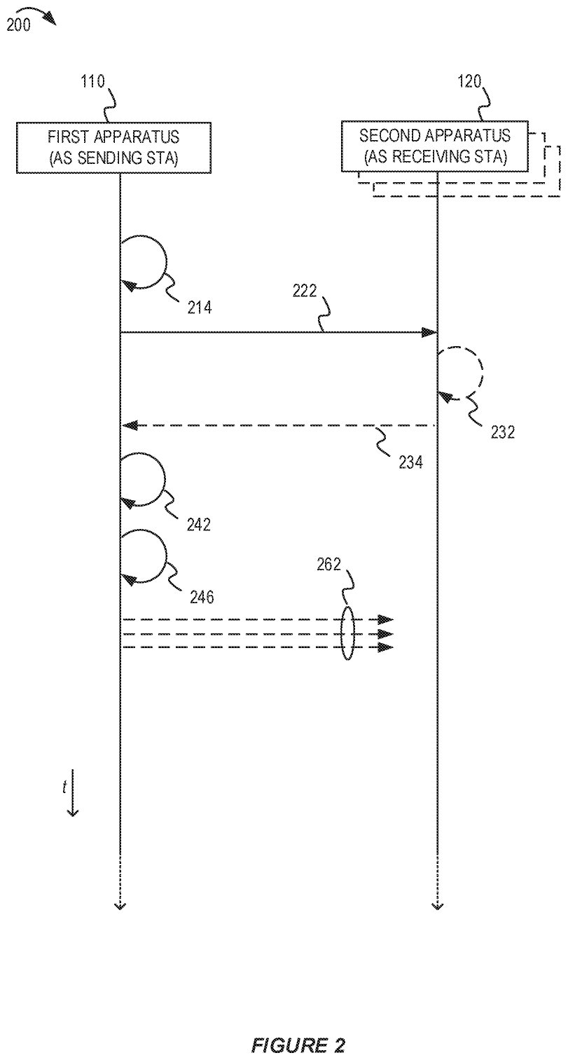

FIG. 1 is used in coordination with the message flow diagrams in FIGS. 2-5.

FIG. 2 depicts a message flow diagram 200 showing example messages for a candidate address test procedure to determine if an LAA is available. A first apparatus 110 may be a first STA and may or may not be associated with an AP. The flow diagram 200 shows a second apparatus 120 as an example of another STA in the vicinity of the first apparatus 110. At process 214, the first apparatus 110 may determine a candidate network address from among a locally administered address range. The first apparatus 110 may send a test frame 222 to determine whether the candidate network address is being used on the communication medium. Several options for the test frame 222 are described below. If the second apparatus 120 is using the candidate network address, then second apparatus 120 may receive the test frame at process 232. The second apparatus 120 may transmit a response 234. At process 242, the first apparatus 110 may determine that the candidate network address is unavailable based on receiving the response 234. At process 246, the first apparatus 110 may determine a new candidate network address and perform the candidate address test again. In some implementations, the first apparatus 110 may send multiple test frames 262 before determining that the candidate network address is available.

The candidate address test may include the first apparatus 110 transmitting a short test frame to the candidate network address, the frame requiring an immediate response. Examples of short frames requiring a response are a request to send (RTS) (the response is a clear to send, CTS), Null (the response is an ACK), QoS-Null (the response is an ACK), etc. A longer frame is also possible but may reduce the range over which address collisions can be detected. When a response is received within a time period (such as a short interframe space, SIFS) after the transmission of the test frame, this indicates that another STA (such as the second apparatus 120) in the vicinity of the first apparatus 110 is using this address.

This disclosure describes several types of test frames that may be used. For example, the test frame may be an RTS, a Null Frame, or a QoS Null frame, among other examples. A CTS will not be transmitted when the second apparatus 120 with a matching address has a NAV set. Therefore, before sending an RTS as a test frame, the STA should ascertain that it is in sync with any NAV being set in its vicinity. Typically, a wait time of several milliseconds will be sufficient to this end.

An aspect of a (QoS-)Null frame is that it also contains the address of the BSS (the BSSID). However, the IEEE 802.11 technical specification specifies that an ACK frame shall be transmitted when the received frame has a matching receiver address (RA). Therefore, the expectation is that STAs will send an ACK response also when the BSSID does not match the BSSID to which the STAs are associated. Therefore, it is likely not needed to repeat the test at different BSSIDs.

An RTS frame has two address fields, A1 and A2. A1 is normally the receiver address (RA) and A2 the transmitter address (TA). When the RTS is used for address collision detect, the RA may be the tested address, but for the TA there may be several options. One option is to use the tested address here as well, in which case the RTS will have the same address in the RA and the TA. Another option is that the RA is set to a predefined (globally registered) address, which then also identifies the RTS as transmitted for the purpose of an address collision detect. A third option is to set the RA of the RTS to another randomly selected locally administered address. Other options may be possible. The addressing options for an RTS are summarized in Table 1.

TABLE 1
Addressing options for RTS frame used
for address collision detect.

| A1 (RA) | A2 (TA) |
|---|---|
| tested address | tested address |
| tested address | predefined global address |
| tested address | random locally |
| | administered address |

The predefined global address in A2 is assumed to be defined by the 802.11 standard. The address is assumed to have been assigned to the standards body by the IEEE standards association (IEEE-SA), which means that it will never be used to designate a physical device interface (because unicast MAC addresses assigned by the IEEE-SA are unique). The address may also have been obtained from an existing device that has been rendered inoperable, for example when the device has been placed on display in a Wi-Fi museum.

A QoS-(Null) frame has three addresses, A1, A2, and A3. A1 is the receiver address (RA) and contains the tested address. A2 is the transmitter address (TA), for which the same options apply as for the TA in the RTS frame. A3 contains the destination address in case of a transmission from a STA to an AP. Options for A3 may be the same as the options for A2. Some addressing options for a QoS-Null are summarized in Table 2. In some implementations, there may be more possible combinations or different options for A2 and A3.

TABLE 2
Addressing options for (QoS-)Null frame
used for address collision detect.

| A1 | A2 | A3 |
|---|---|---|
| tested address | tested address | tested address |
| tested address | predefined global address | predefined global address |
| tested address | random locally | random locally |
| | administered address | administered address |

The second apparatus 120 using the same address as the tested address may be in mode that temporarily disables its reception or its ability to respond on a given channel (like power save, scanning, discovery, or channel switch, among other examples). Thus, the second apparatus 120 may not respond to the address collision test frame, which could result in the first apparatus 110 to end up using a colliding address (because it saw no response to its test frame). To this end, each time a STA (such as the first apparatus 110 or the second apparatus 120) resumes listening on a channel after a period of absence, the STA may send a test frame to the random address that it has been using. When a response is received and therefore an address collision is detected, the STA may select a new MAC address, test it, and establish a connection with the AP using the new address before continuing communications with the AP.

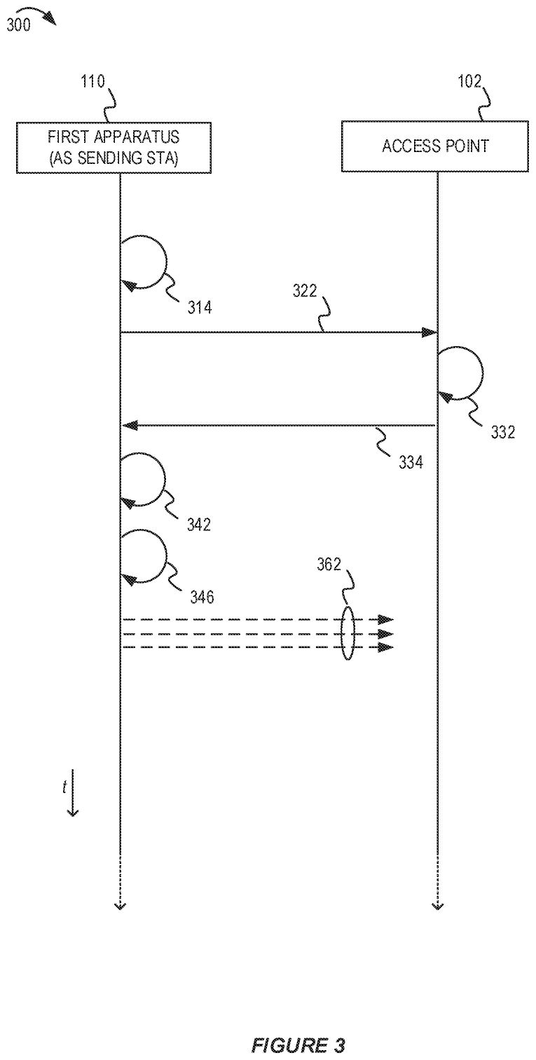

FIG. 3 depicts a message flow diagram showing example messages for an AP assisted process for determining a free LAA. The message flow diagram 300 in FIG. 3 may be used to describe several option features.

The candidate address test described in FIG. 2 may establish whether there is an address collision with STAs that are within reach of the test frame (such as those on the same communication medium). But when the layer two domain (referred to as “L2 domain”) is extended through an ESS, mesh, or relay, an address collision may still exist within the L2 domain to which the first apparatus 110 intends to be connected, but outside the wireless reach of the test frame. In some implementations, in addition to the candidate address test, the L2 domain (such as an AP 102) may maintain a list of the (randomized) addresses currently in use in the domain. Once the candidate address test succeeds (at process 314), the first apparatus 110 may attempt to associate (at message 322) with the AP 102 using the locally tested randomized address. The AP 102 may check (at process 332) whether an address collision exists with an existing connection in the L2 domain, before accepting the association. The association request (at message 322) for association may indicate that the address used is a newly randomized address which is intended to be used for the first time in the network. An association response (at message 334) may indicate whether the candidate network address is free. At process 342, the first apparatus 110 may use the free candidate network address to communicate further messages 362 with the AP 102.

As described in several examples of this disclosure, the address may be selected from a locally administered address (LAA) space. In some implementations, the address may be selected from a global address space, possibly in combination with collision detect mechanisms and address change mechanisms. For example, all or a portion of the global address space may be reserved for temporary addresses, possibly overlapping with assigned non-temporary addresses. Thus, the examples describing an LAA in this disclosure also may be used with a temporary address selected from a global address space.

A candidate address check request frame can be defined in a technical specification. The candidate address check request frame (such as message 322) may include a list of candidate network addresses (determined by the first apparatus 110 at process 314). At process 332, the AP 102 may select an address that is not currently in use in the ESS and inform the first apparatus 110 of this in a candidate address check response frame (such as message 334).

In some implementations, the candidate address check request frame may use a temporary random address for the first apparatus 110. The temporary random address can be part of the suggested list of addresses. The temporary random address may be verified before use using a candidate address test (as described in FIG. 2).

In some implementations, the AP 102 may assign an LAA for the first apparatus 110. An address request frame can be sent (such as message 322) to the AP 102. The AP 102 may respond with an address request response frame (such as message 334) containing one or more random MAC address that are available according to information available to the AP (such as an address that is not in use in the L2 domain). The information may be obtained from receptions on the channel and from a database with random MAC addresses currently in us in the ESS. Prior to sending the address the AP 102 may perform a candidate address test by sending an address collision test frame. Before using the address offered by the AP 102, the first apparatus 110 may perform a candidate address test by sending an address collision test frame. The first apparatus 110 may assume a temporary random address for the transmission of the candidate address check request frame. The temporary random address can be part of the suggested list of addresses. The temporary random address may be verified before use using an address collision test frame.

Temporary addresses may be selected from a local address space that is not used for regular random MAC addresses (such that the random address space is partitioned into a space with one-time used temporary random addresses and longer-term used random addresses). In some implementations, the temporary addresses may be selected from a global address space, possibly in combination with collision detect mechanisms and address change mechanisms. For example, all or a portion of the global address space may be reserved for use as a temporary address, possibly overlapping with assigned non-temporary addresses. Thus, the examples describing an LAA in this disclosure also may be used with a temporary address selected from a global address space.

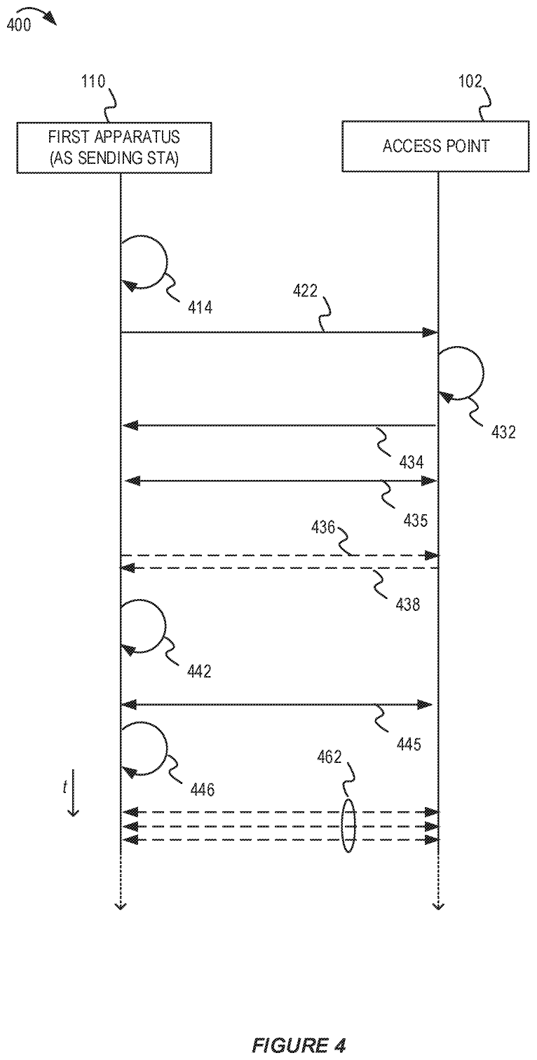

FIG. 4 depicts a message flow diagram showing example messages for an AP to coordinate with a STA to use multiple LAAs. In some implementations, the first apparatus 110 may use a first candidate network address as a primary address and may use a second candidate network address as a secondary address. At process 414, the secondary address may be randomly selected and tested similar to the primary address. The first apparatus 110 may use the primary address for an association request (at message 422) and receive an association response (at message 434). The secondary address may be communicated (at message 435) to the AP after association using a (secured) communication on the primary address.

When either the first apparatus 110 or the AP 102 detects an address collision on the primary address, they may send a notification (at messages 436, 438, respectively) to indicate the address collision. The notification may use the secondary address to communicate between the first apparatus 110 and the AP 102 to determine how to proceed after the address collision. In some implementations, the secondary address may be upgraded to become to the primary address. The AP 102 may select a new secondary address. In some implementations, the secondary address may remain the same and a new primary address may be selected. The AP 102 and the first apparatus 110 may inform (at message 445) the other regarding the new primary address or the new secondary address.

In some implementations, transmissions (such as messages 462) may use the primary and the secondary addresses interchangeably. Once one address becomes unusable because of an address collision, the first apparatus 110 may seamlessly switch to the other address and update the colliding address with the AP 102. The first apparatus 110, the AP 102, or both, may periodically check whether a collision exists on either of the primary or secondary addresses of the first apparatus 110. When no collision was detected on its primary address, and the primary address may be the preferred address for data communications. In some implementations, the first apparatus 110 may not accept data frames transmitted to its secondary address when the primary address has not had an address collision. A collision also may be detected on the secondary address. In this case, the first apparatus 110 may use the primary address to communicate to the AP 102 to change the secondary address. In similar fashion, a tertiary address may be added.

In secured communications, the MAC address may be used to determine a message integrity check (MIC), which is appended (by the AP 102) to the frame to check the integrity of the frame at the first apparatus 110. Since the same security association is used both the primary and the secondary address, the first apparatus 110 may be able to ascertain the integrity of frames regardless of whether the primary or secondary address is used.

Alternatively, a MAC address change is performed using the nontransparent FST procedure. The nontransparent FST procedure may be originally designed to allow fast switching between different bands where different MAC addresses are used in each band. However, in accordance with this disclosure, the FST procedure may be modified to support switching addresses while staying on the same channel.

An FST session is set up (such as messages 435) through the FST Setup Request and FST Setup Response frames. Once an FST session is set up, a switch is executed through the FST Ack Request and FST Ack Response frames (such as messages 445). However, when an address collision is detected, the current MAC address at the STA may be unavailable. To this end, the FST Ack Request and FST Ack Response frames may be replaced with token frames. Different tokens are used for FST Ack Request and FST Ack Response. The tokens may be negotiated as part of the FST session setup (using secure frames) or in a separate secure exchange. The token may be large enough to avoid a brute force attack.

The AP 102 may detect an address collision for one of its STAs (such as the first apparatus 110) and send an address collision notification frame to the first apparatus 110 to inform the first apparatus 110 of the address collision. The address collision notification frame may be regular protected (secure) frame or a token frame with a token that has been pre-negotiated between the AP 102 and first apparatus 110. The address collision notification token frame may be transmitted to a predefined address which is the same for all address collision notification frames (and only the token differs).

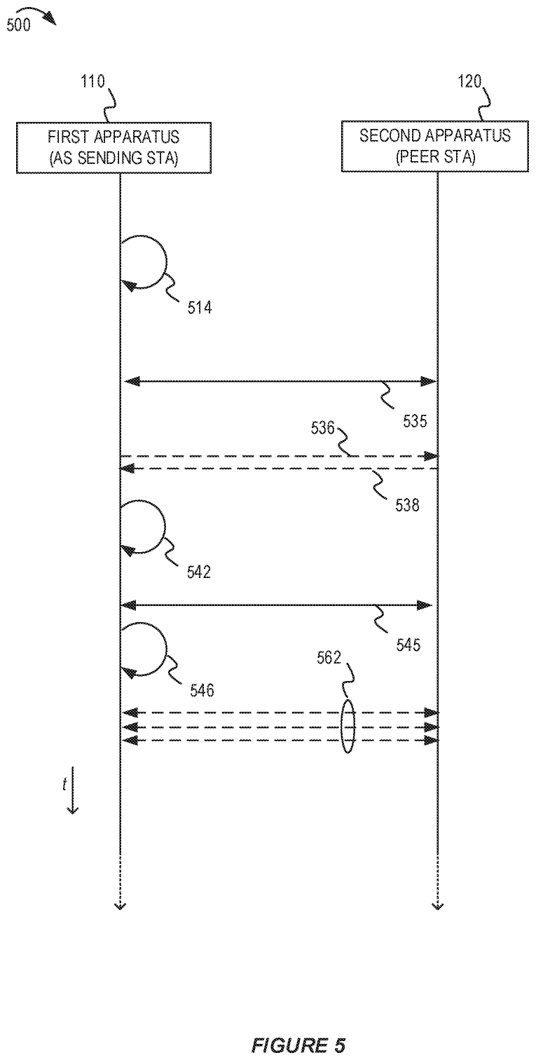

FIG. 5 depicts a message flow diagram showing example messages for peer relationship in which at least one apparatus is using an LAA. A Tunneled Direct Link Setup (TDLS) direct link is a direct link between two STAs (such as the first apparatus 110 and the second apparatus 120). A TDLS direct link may be set up using signaling messages that are tunneled through an AP 102 (not shown in FIG. 5). In FIG. 5, the first apparatus 110 is using an LAA (determined at process 514). A TDLS direct link may be set up at messages 535. When one of the TDLS STAs (such as the first apparatus 110) changes its address (at process 542), the first apparatus 110 may send its new address to the TDLS peer STA using a TDLS Address Change Request frame (at message 545). For example, the TDLS peer STA (the second apparatus 120) may respond with a TDLS Address Change Response frame. The TDLS Address Change Request frame and the TDLS Address Change Response frame are newly defined TDLS frames, which are tunneled through the AP like the TDLS setup frames.

The TDLS Address Change Request frame and the TDLS Address Change Response frame may be the tunneled variants of the FST Ack Request frame and the FST Ack Response frame when an FST session is used by the TDLS STAs for the address switch. The FST Setup Request and FST Setup Response frames also require tunneled variants in this case. Tunneled variants of the FST Setup Request, FST Setup Response, FST Ack Request, and FST Ack Response frames can be created by inserting the FST Setup Request, FST Setup Response, FST Ack Request, and FST Ack Response Action field, respectively, in an Ethertype 89-0d frame in the same way the TDLS Action fields are inserted in an Ethertype 89-0d frame. The Category subfield of the Action field allows to differentiate between the TDLS Action fields and the FST Action fields.

Another option for TDLS is to use a token frame which replaces the FST Ack Request and the FST Ack Response frames. The tokens are negotiated at the time the FST session is set up between the TDLS peer STAs. The token frame may be transmitted via the direct link. The token frame may be transmitted via the AP by defining a TDLS Token frame as a new TDLS frame. A new TDLS Action field is defined to contain a token. The A3 field (the source address) of the TDLS Token frame may be the existing or the new random address of the STA, because the token itself is used by the TDLS peer STA to identify the FST session to which it pertains (such that the source address may not be needed in this case).

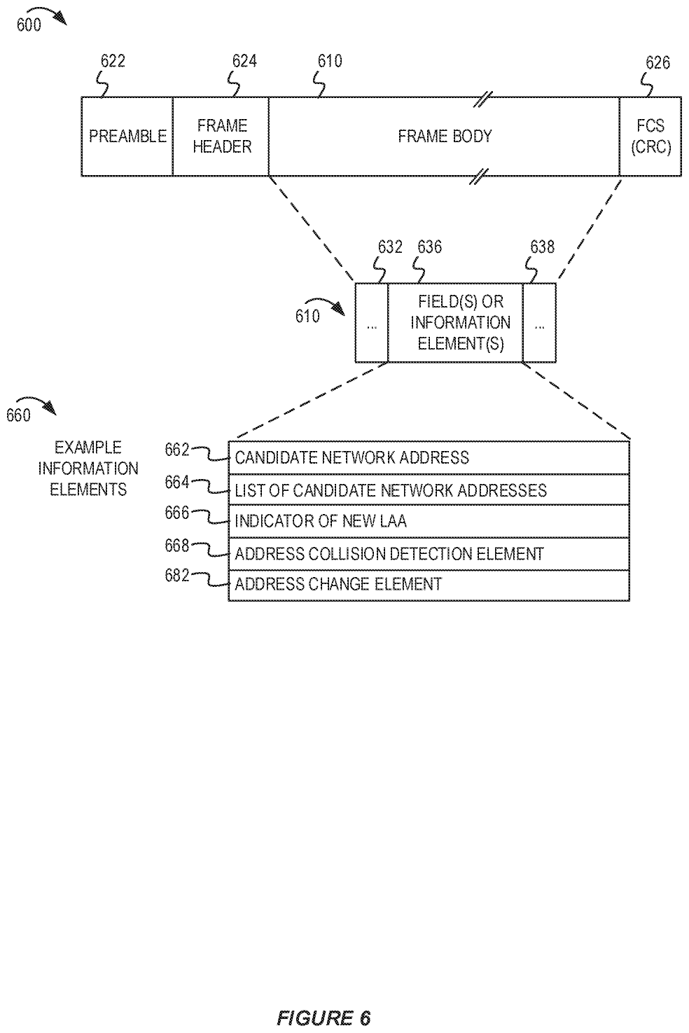

FIG. 6 depicts a conceptual diagram of an example configuration message for use in an LAA protocol. For example, the example message 600 may be sent from a first WLAN device to a second WLAN device, or vice versa. The example message 600 may include a preamble 622, a header 624, a payload 610, and a frame check sequence (FCS) 626. The preamble 622 may include one or more bits to establish synchronization. The preamble 622 may be used, for example, when a dedicated discovery channel uses a listen-before-talk, contention-based access, or carrier sense access. In some implementations, if the dedicated discovery channel uses a scheduled timeslot for transmission, the preamble 622 may be omitted. The header 624 may include source and destination network addresses (such as the network address of the sending AP and receiving AP, respectively), the length of data frame, or other frame control information. In some implementations, the header 624 also may indicate a technology type associated with a technology-specific payload (if the payload 610 is specific to a particular technology type or types). The payload 610 may be organized with a message format and may include information elements 632, 636, and 638. Several examples of information elements are illustrated in FIG. 6.

Example information elements 660 may be sent as part of a candidate address test, an extended address test, an association, an FST setup, or an address change message, among other examples. The example information elements 660 may include a candidate network address 662, a list of candidate network addresses 664, an indicator of a new LAA 666, an address collision detection element 668, or an address change element 682, among other examples.

Although FIG. 6 describes some examples how a message may communicate regarding an address selection or address change, there may be other example implementations. For example, a wireless communication standard may define the formatting of messages for any of the LAA protocols described herein. A message may be formatted to carry different information elements. In some implementations, an existing information element may be modified to include a new field for the LAA protocol information. In another example, a new sub-element (such as an optional sub-element in an existing message element) may be defined for the LAA protocol information. In some implementations, an existing field may be repurposed to carry the LAA protocol information.

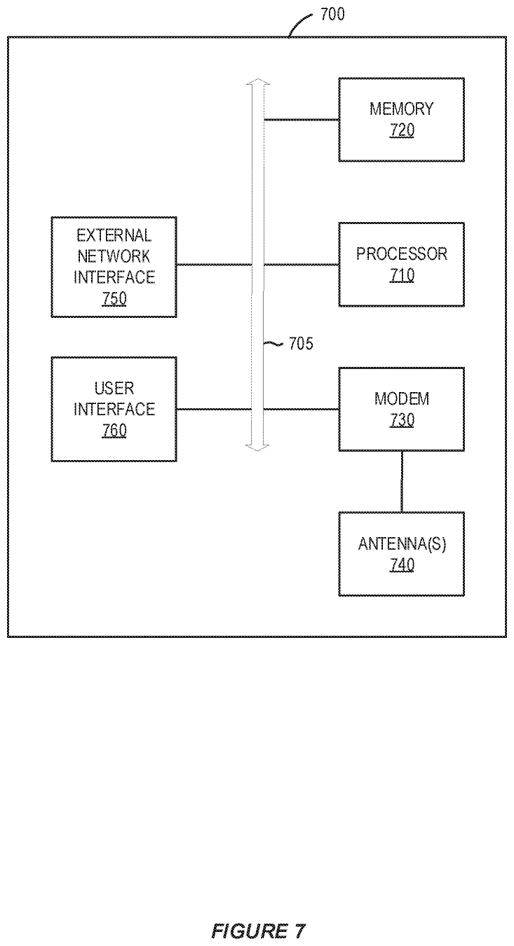

FIG. 7 shows a block diagram of an example AP 700 for use in wireless communication. For example, the AP 700 may be an example of aspects of the AP 102 described with reference to FIG. 1. The AP 700 is capable of transmitting and receiving wireless communications (for example, in the form of wireless packets), as well as of encoding and decoding such communications. For example, the wireless communications can include Wi-Fi packets including frames conforming to an IEEE 802.11 standard. The AP 700 includes at least one processor 710 (collectively “the processor 710”), at least one memory 720 (collectively “the memory 720”), at least one modem 730 (collectively “the modem 730”), at least one antenna 740 (collectively “the antenna 740”), at least one external network interface 750 (collectively “the network interface 750”) and, in some instances, a user interface (UI) 760. Each of the components (or “modules”) described with reference to FIG. 7 can communicate with other ones of the components, directly or indirectly, over at least one bus 705.

The processor 710 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 710 processes information received through the modem 730 and the external network interface 730. The processor 710 also can process information to be sent to the modem 730 for transmission through the antenna 740 and information to be sent to the external network interface 730. The processor 710 can generally be configured to perform various operations related to generating and transmitting a downlink frame and receiving an uplink frame.

The memory 720 can include random access memory (RAM) and read-only memory (ROM). The memory 720 also can store processor- or computer-executable software (SW) code containing instructions that, when executed by the processor 710, cause the processor to perform various functions described herein for wireless communication, including generation and transmission of a downlink frame and reception of an uplink frame.

The modem 730 is generally configured to modulate packets and to provide the modulated packets to the antenna 740 for transmission, as well as to demodulate packets received from the antenna 740 to provide demodulated packets. The modem 730 generally includes or is coupled with at least one radio frequency (RF) transmitter and at least one RF receiver, which may be combined into one or more transceivers, and which are in turn coupled to one or more antennas 740. For example, in some AP implementations, the AP 700 can include multiple transmit antennas (each with a corresponding transmit chain) and multiple receive antennas (each with a corresponding receive chain). The modem 730 can communicate bi-directionally, via the antenna 740, with at least one STA (such as the STA 104 described with reference to FIG. 1).

The modem 730 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 710 for processing, evaluation, or interpretation, for example, by one or more host applications executing on the processor.

The AP 700 may communicate with a core or backhaul network through the external network interface 750 to gain access to external networks including the Internet. For example, the external network interface 750 may include one or both of a wired (for example, Ethernet) network interface or wireless (for example, LTE, 4G or 5G) network interface.

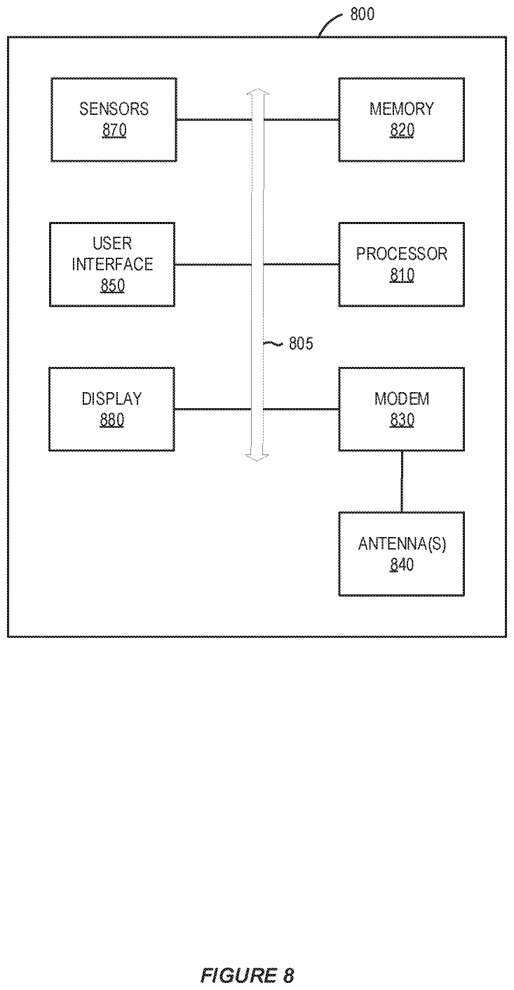

FIG. 8 shows a block diagram of an example STA 800 for use in wireless communication. For example, the STA 800 may be an example of aspects of the STA 104 (or the first apparatus 110 or the second apparatus 120) described with reference to FIG. 1. The STA 800 is capable of transmitting and receiving wireless communications, as well as of encoding and decoding such communications. The wireless communications may conform to any of a number of different wireless communication protocols. For example, the STA 800 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, and 802.11ba). Additionally, or alternatively, the STA 800 may be capable of transmitting and receiving Bluetooth packets conforming to a Bluetooth standard, such as defined in IEEE 802.15 or by the Bluetooth SIG. Additionally, or alternatively, the STA 800 may be capable of transmitting and receiving wireless packets associated with the Long-Term Evolution (LTE), International Mobile Telecommunications-Advanced (IMT-Advanced) 4G or 5G standards.

The STA 800 includes at least one processor 810 (collectively “the processor 810”), at least one memory 820 (collectively “the memory 820”), at least one modem 830 (collectively “the modem 830”) and at least one antenna 840 (collectively “the antenna 840”). In some implementations, the STA 800 additionally includes some or all of the following: a user interface (UI) 850 (such as a touchscreen or keypad), one or more sensors 870 (such as one or more inertial sensors, accelerometers, temperature sensors, pressure sensors, or altitude sensors), and a display 880. Each of the components (or “modules”) described with reference to FIG. 1 can communicate with one another, directly or indirectly, over at least one bus 805.

The processor 810 includes an intelligent hardware device such as, for example, a CPU, a microcontroller, an ASIC or a PLD such as an FPGA, among other possibilities. The processor 810 processes information received through the modem 830 as well as information to be sent to the modem 830 for transmission through the antenna 840. The processor 810 can be configured to perform various operations related to receiving a downlink frame and generating and transmitting an uplink frame.

The memory 820 can include RAM and ROM. The memory 820 also can store processor- or computer-executable SW code containing instructions that, when executed, cause the processor 810 to perform various functions described herein for wireless communication, including reception of a downlink frame and generation and transmission of an uplink frame.

The modem 830 is generally configured to modulate packets and provide the modulated packets to the antenna 840 for transmission, as well as to demodulate packets received from the antenna 840 to provide demodulated packets. The modem 830 generally includes or is coupled with at least one radio frequency (RF) transmitter and at least one RF receiver, which may be combined into one or more transceivers, and which are in turn coupled to one or more antennas 840. For example, in some implementations, the STA 800 can include multiple transmit antennas (each with a corresponding transmit chain) and multiple receive antennas (each with a corresponding receive chain). The modem 830 can communicate bi-directionally, via the antenna 840, with at least one AP (such as the AP 102 or AP 800 described with reference to FIGS. 1 and 4, respectively). As is described above, in some implementations, the modem also can communicate bi-directionally, via the antenna 840, with other STAs directly without the use of an intermediary AP.

The modem 830 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 810 for processing, evaluation, or interpretation, for example, by one or more host applications executing on the processor.

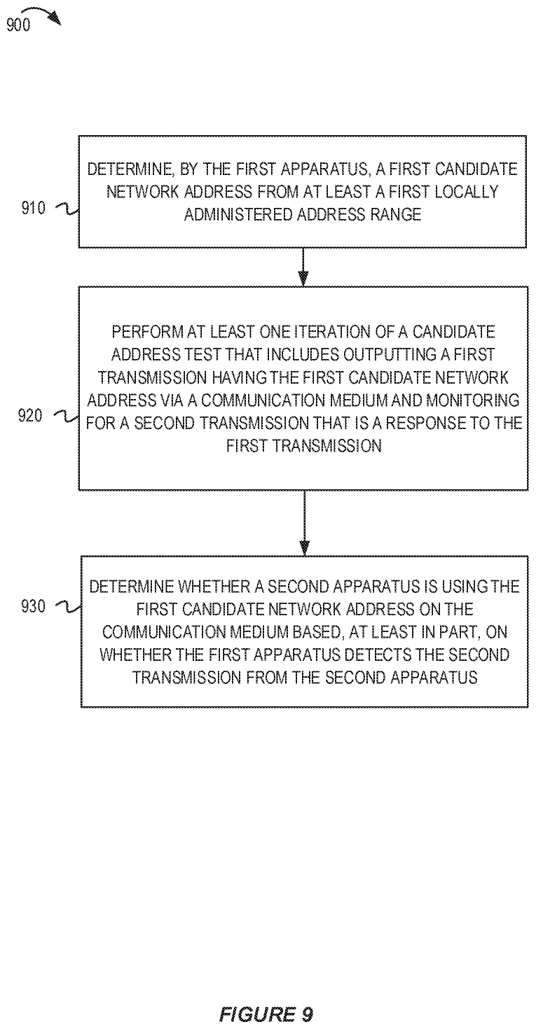

FIG. 9 depicts an example flowchart for a STA performing a candidate address test. In some implementations, the process 900 may be performed by a first apparatus (such as one of the STAs 104, 110, 120, and 800 described above with reference to FIGS. 1-8, respectively).

In block 910, the first apparatus may determine a first candidate network address from at least a first locally administered address range. In block 920, the first apparatus may perform at least one iteration of a candidate address test that includes outputting a first transmission having the first candidate network address via a communication medium and monitoring for a second transmission that is a response to the first transmission. In block 930, the first apparatus may determine whether a second apparatus is using the first candidate network address on the communication medium based, at least in part, on whether the first apparatus detects the second transmission from the second apparatus.

In some implementations, the first apparatus may determine that the first candidate network address is available for use by the first apparatus if the first apparatus does not detect the second transmission during a time period following the first transmission. The first apparatus may use the first candidate network address as a locally administered MAC address of the first apparatus in a network.

In some implementations, the first transmission may include a clear to send (CTS) frame, a QoS Null frame, or a Non-QoS Null frame. In some implementations, before outputting the first transmission, the first apparatus may synchronize a network allocation vector (NAV) associated with the communication medium.

In some implementations, after a period of absence during which the first apparatus is not monitoring the communication medium, the first apparatus may perform another iteration of the candidate address test to verify that the first candidate network address remains available for use by the first apparatus. In some implementations, after a period during which the first apparatus was unable to send a response frame (for example because its NAV was set) but it observed a candidate address test using its address, the first apparatus may perform a candidate address test to verify that its network address remains available for use by the first apparatus.

In some implementations, the first apparatus may perform another iteration of the candidate address test after each time the first apparatus returns to the communication medium following another period of absence. The period of absence may be is associated with a power save mode, a channel scanning operation, a discovery operation, or a channel switch.

In some implementations, the first apparatus may perform an extended address test to determine whether the first candidate network address is used by another apparatus on another communication medium associated with a network. The extended address test may be used to determine whether another apparatus is using the first candidate network address within a data link layer domain of the network.

In some implementations, the first apparatus may determine a second candidate network address from the first locally administered address range. The first apparatus may use the first candidate network address as a primary address of the first apparatus and the second candidate network address as a secondary address of the first apparatus.

In some implementations, the first apparatus may determine that another apparatus is using the primary address and may switch to the secondary address for subsequent communication with the network.

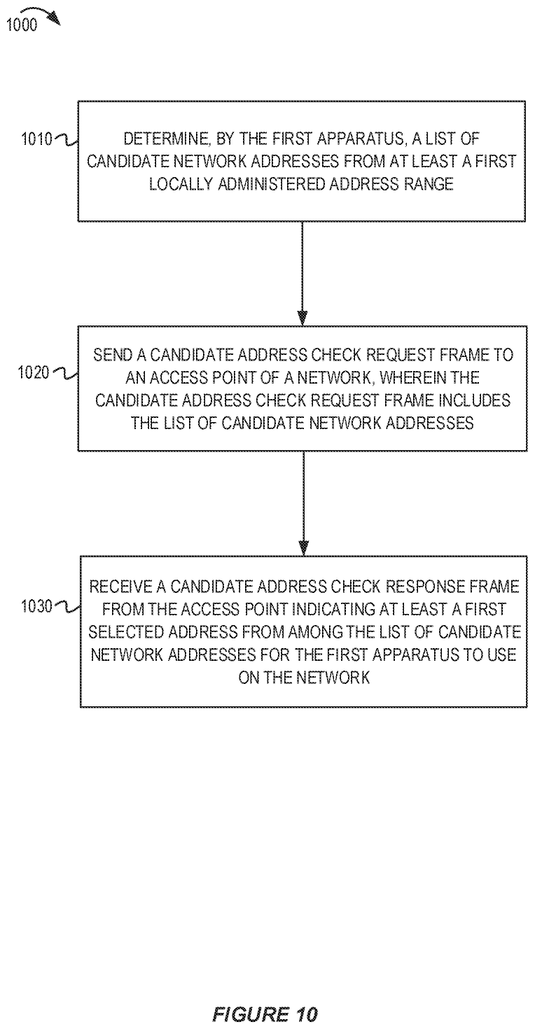

FIG. 10 depicts an example flowchart for a STA to use an AP to assist with selecting an LAA. In some implementations, the process 1000 may be performed by a first apparatus (such as one of the STAs 104, 110, and 800 described above with reference to FIGS. 1-8, respectively).

In block 1010, first apparatus may determine a list of candidate network addresses from at least a first locally administered address range. In block 1020, the first apparatus may send a candidate address check request frame to an access point of a network. The candidate address check request frame may include the list of candidate network addresses. In block 1030, the first apparatus may receive a candidate address check response frame from the access point indicating at least a first selected address from among the list of candidate network addresses for the first apparatus to use on the network.

In some implementations, the first apparatus may use a temporary address as a transmitting address of the first apparatus in the candidate address check request frame. The temporary address may be a randomly selected addressed from a reserved pool of temporary addresses different from the first locally administered address range.

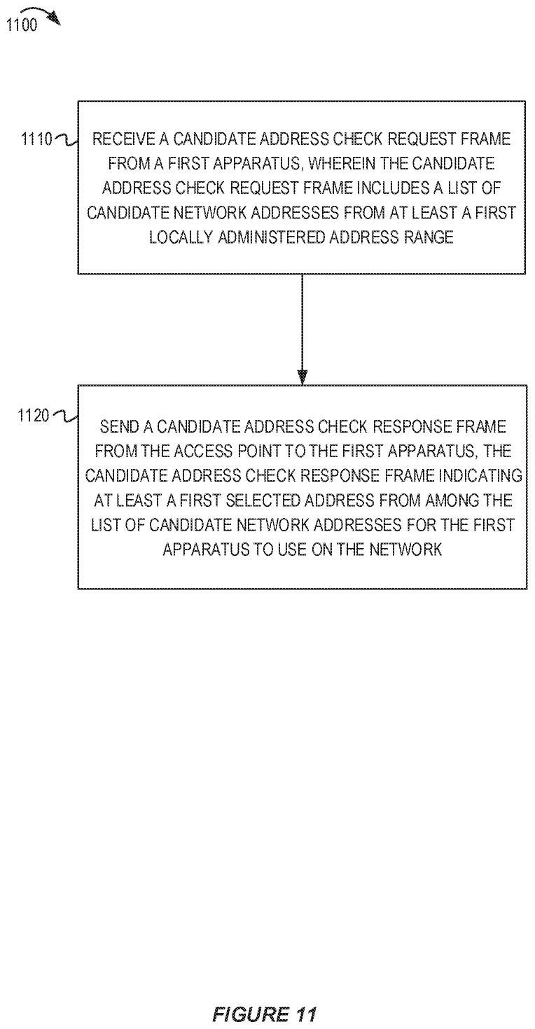

FIG. 11 depicts an example flowchart for an AP to assist with selecting an LAA. In some implementations, the process 1100 may be performed by a network apparatus (such as the AP 102 described above with reference to FIGS. 1-8, respectively).

In block 1110, the network apparatus may receive a candidate address check request frame from a first apparatus. The candidate address check request frame may include a list of candidate network addresses from at least a first locally administered address range. In block 1120, the network apparatus may send a candidate address check response frame from the access point to the first apparatus, the candidate address check response frame indicating at least a first selected address from among the list of candidate network addresses for the first apparatus to use on the network.

In some implementations, the network apparatus may perform an extended address test to determine whether the first selected address is used by another apparatus on another communication medium associated with the network.

In some implementations, the network includes an extended service set (ESS) with one or more basic service sets (BSSs). The extended address test may be used to determine whether another apparatus is using the first selected address within the ESS.

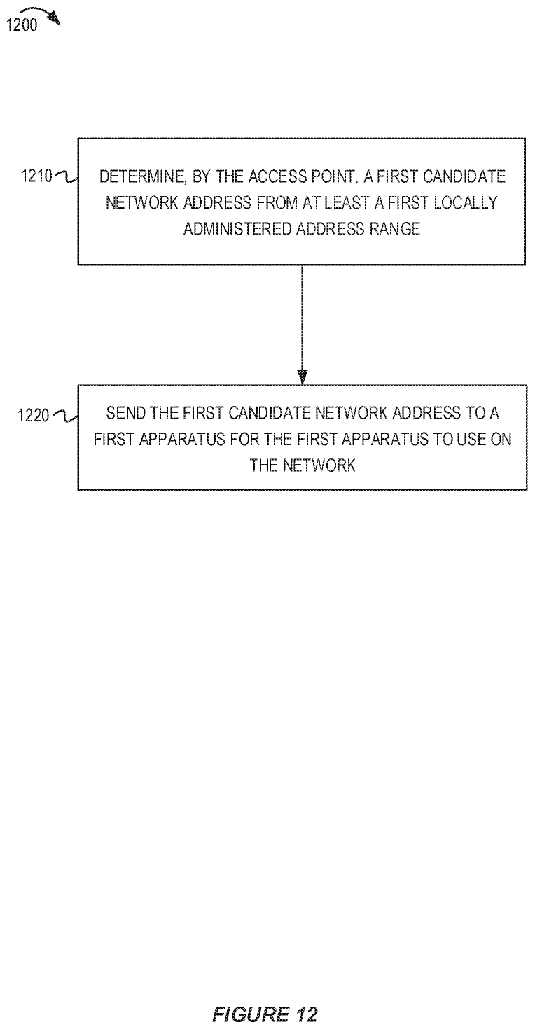

FIG. 12 depicts an example flowchart for an AP that assigns an LAA to a STA. In some implementations, the process 1200 may be performed by a network apparatus (such as the AP 102 described above with reference to FIGS. 1-8, respectively).

In block 1210, the access point may determine a first candidate network address from at least a first locally administered address range determining, by the access point, a first candidate network address from at least a first locally administered address range. In block 1220, the access point may send the first candidate network address to a first apparatus for the first apparatus to use on the network.

In some implementations, the access point may perform at least one iteration of a candidate address test that includes outputting a first transmission having the first candidate network address via a communication medium and monitoring for a second transmission that is a response to the first transmission. The access point may determine whether a second apparatus is using the first candidate network address on the communication medium based, at least in part, on whether the first apparatus detects the second transmission from the second apparatus.

In some implementations, the access point may perform an extended address test to determine whether the first candidate network address is used by another apparatus on another communication medium associated with the network. In some implementations, a STA may request the access point to perform a local or extended address test on an address it intends to use.

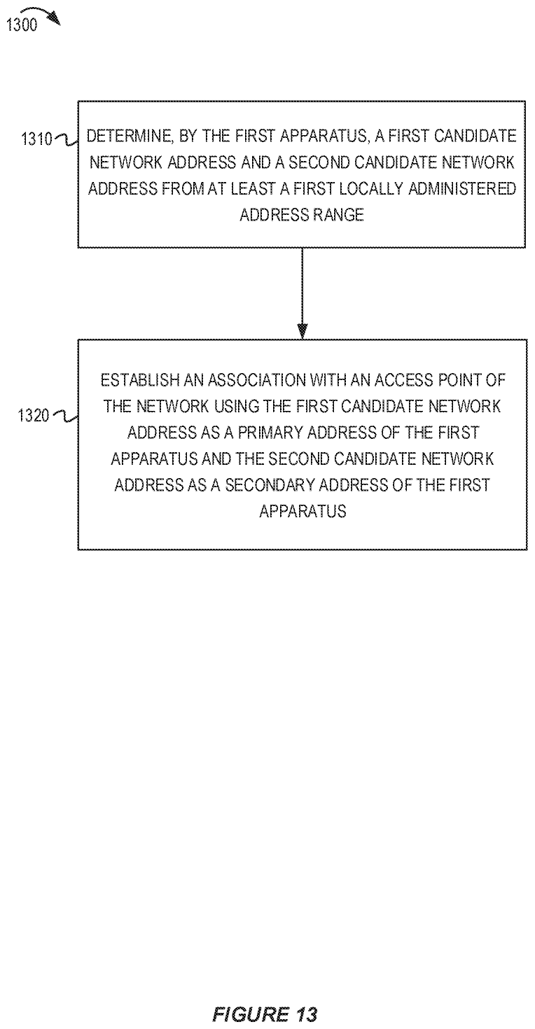

FIG. 13 depicts an example flowchart for a STA using a fast session transfer (FST) procedure with an AP. In some implementations, the process 1300 may be performed by a first apparatus (such as one of the STAs 104, 110, and 800 described above with reference to FIGS. 1-8, respectively).

In block 1310, the first apparatus may determine a first candidate network address and a second candidate network address from at least a first locally administered address range. In block 1320, the first apparatus may establish an association with an access point of the network using the first candidate network address as a primary address of the first apparatus and the second candidate network address as a secondary address of the first apparatus.

In some implementations, the first apparatus may be configured to receive transmissions from the access point interchangeably using either the primary address or the secondary address.

In some implementations, the first apparatus the first apparatus is configured to receive transmissions from the access point using the primary address until an address collision of the primary address is detected. The secondary address may be used after the address collision is detected.

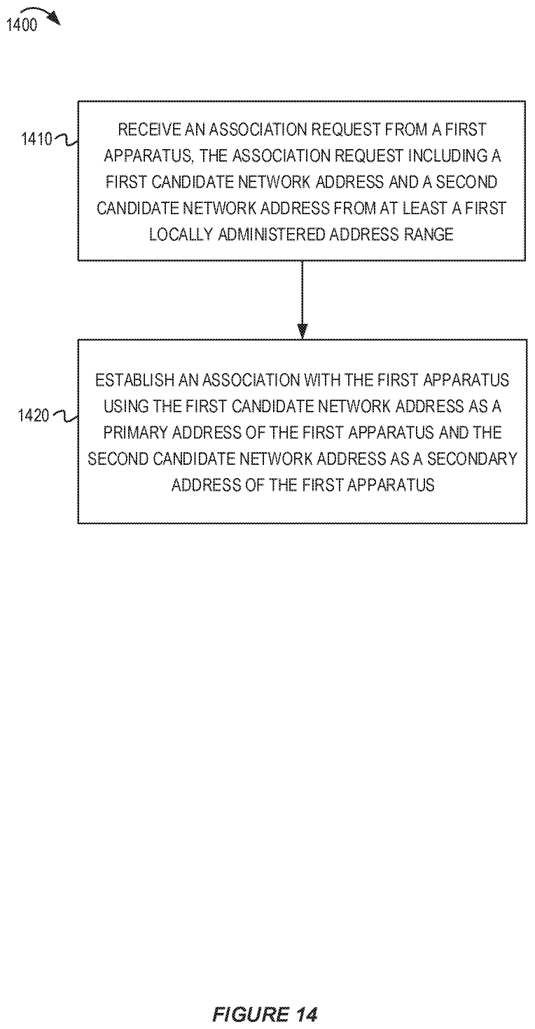

FIG. 14 depicts an example flowchart for an AP supporting an FST procedure with a STA. In some implementations, the process 1400 may be performed by a network apparatus (such as the AP 102 described above with reference to FIGS. 1-8, respectively).

In block 1410, the network apparatus may receive an association request from a first apparatus, the association request including a first candidate network address and a second candidate network address from at least a first locally administered address range. In block 1420, the network apparatus may establish an association with the first apparatus using the first candidate network address as a primary address of the first apparatus and the second candidate network address as a secondary address of the first apparatus.

In some implementations, the access point may perform a fast session transfer (FST) procedure to change from the primary address to the secondary address.

In some implementations, the FST procedure may include receiving an FST message with a pre-arranged token between the first apparatus and the access point.

In some implementations, the access point may establish the pre-arranged token as part of an FST session setup or secure message exchange.

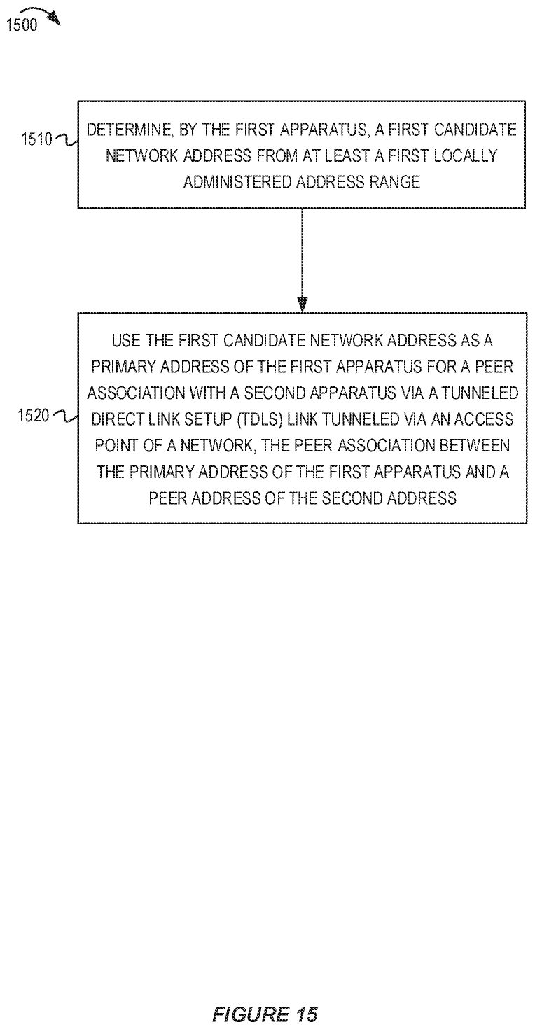

FIG. 15 depicts an example flowchart for a STA performing an address change with a peer STA. In some implementations, the process 1500 may be performed by a first apparatus (such as one of the STAs 104, 110, and 800 described above with reference to FIGS. 1-8, respectively).

In block 1510, the first apparatus may determine a first candidate network address from at least a first locally administered address range. In block 1520, the first apparatus may use the first candidate network address as a primary address of the first apparatus for a peer association with a second apparatus via a tunneled direct link setup (TDLS) link tunneled via an access point of a network, the peer association between the primary address of the first apparatus and a peer address of the second address.

In some implementations, the first apparatus may determine that an address collision of the primary address has been detected on the network. The first apparatus may determine a second candidate network address from at least the first locally administered address range. The first apparatus may send a TDLS Address Change Request frame to the second apparatus to change the primary address to the second candidate network address.

In some implementations, the TDLS Address Change Request frame may be tunneled via the peer association to the second apparatus. The TDLS Address Change Request frame may include a fast session transfer (FST) message.

In some implementations, the TDLS Address Change Request frame may be inserted in an Ethertype 89-0d frame.

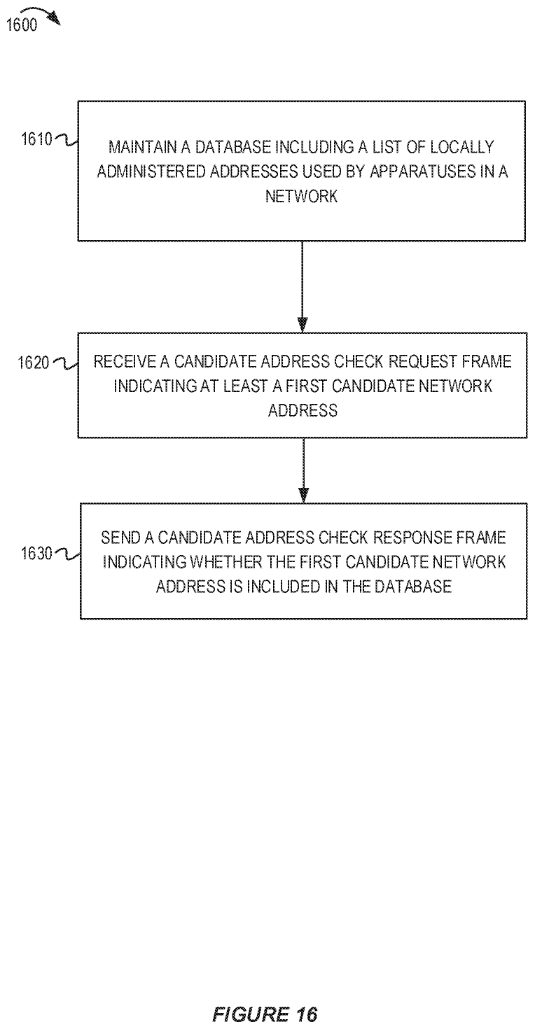

FIG. 16 depicts an example flowchart for a central resource that supports LAA address collision prevention. In some implementations, the process 1600 may be performed by a central resource (such as a server or a central access point). In block 1610, the central resource may maintain a database including a list of locally administered addresses used by apparatuses in a network. In block 1620, the central resource may receive a candidate address check request frame indicating at least a first candidate network address. In block 1630, the central resource may send a candidate address check response frame indicating whether the first candidate network address is included in the database.

In some implementations, the database is included in an access point of the network.

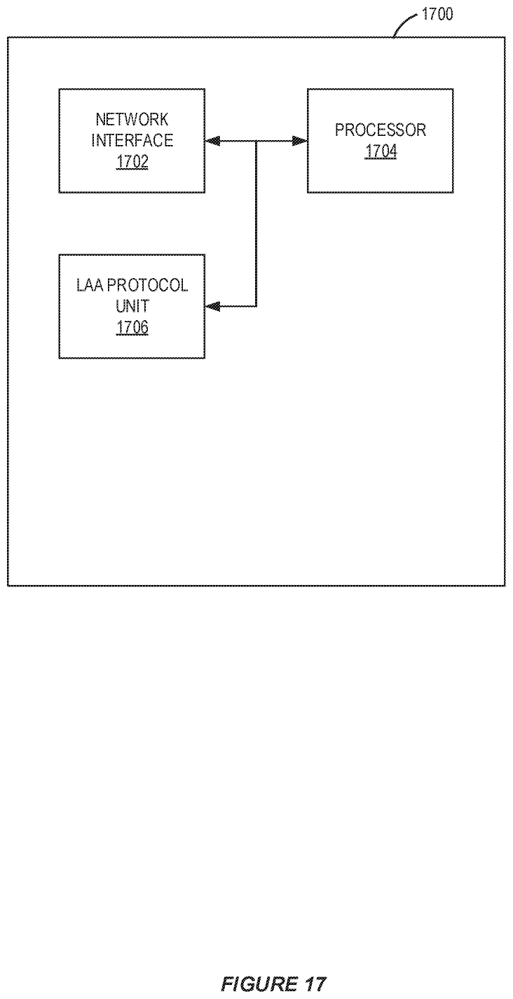

FIG. 17 shows a block diagram of an example apparatus 1700 for use in a WLAN device according to some implementations. In some implementations, the apparatus 1700 can be an example of a module, chip, or component for use in a STA such as one of the STAs 104, 110, 120, and 800 described above with reference to FIGS. 1-8, respectively. In some implementations, the apparatus 1700 is configured to perform one or more of the processes described above with reference to FIGS. 9-16, respectively. The apparatus 1700 includes a network interface 1702, a processor 1704, and an LAA protocol unit 1706. Portions of one or more of the modules 1702, 1704, and 1706 may be implemented at least in part in hardware or firmware. For example, the 1702 may be implemented at least in part by one or more modems (for example, a Wi-Fi (IEEE 802.11) modem). In some implementations, at least some of the modules 1702, 1704, and 1706 are implemented at least in part as software stored in a memory (such as the memory 820). For example, portions of one or more of the modules 1702, 1704, and 1706 can be implemented as non-transitory instructions (or “code”) executable by at least one processor (such as the processor 810) to perform the functions or operations of the respective module.

The network interface 1702 is configured to output a test frame such as those for the candidate address test. The network interface 1702 also may be configured to output a candidate address check request frame, an address change request, or other messages described herein.

The processor 1704 is configured to execute operations of the LAA protocol unit 1706.

The LAA protocol unit 1706 is configured to prepare the test frame, the candidate address check request frame, the address change request, other messages described herein.

FIGS. 1-17 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1.-104. (canceled)

105. A method for network communication by a first apparatus comprising:
determining, by the first apparatus, a first candidate network address from at least a first locally administered address range;
performing at least one iteration of a candidate address test that includes outputting a first transmission having the first candidate network address via a communication medium of a network, the first transmission being configured to instigate a second transmission from at least one other apparatus in the network as a response to the first transmission if the first candidate network address is being used by a second apparatus in the network, wherein the candidate address test further includes monitoring for the second transmission during a time period following the first transmission; and
using the first candidate network address as a locally administered media access control (MAC) address of the first apparatus when the first apparatus does not detect the second transmission in the candidate address test.

106. The method of claim 105, further comprising:
determining that first candidate network address is being used by the second apparatus in the network;
determining, by the first apparatus, a second candidate network address from the first locally administered address range; and
performing a second iteration of the candidate address test using the second candidate network address instead of the first candidate network address.

107. The method of claim 106, wherein determining that first candidate network address is being used by the second apparatus in the network includes at least one member selected from a group consisting of:
detecting the second transmission in the candidate address test;
receiving a management frame from an access point that indicates the first candidate network address is being used by the second apparatus in the network;
receiving a notification from the access point that indicates that the access point has detected an address collision of the first candidate network address; and
detecting of any transmission from the second apparatus using the first candidate network address.

108. The method of claim 105, wherein the first transmission indicates the first candidate network address as a receiver address to instigate the second transmission from the second apparatus when the second apparatus is using the first candidate network address in the network.

109. The method of claim 108, wherein the first transmission includes one member selected from a group consisting of a clear to send (CTS) frame, a quality of service (QoS) Null frame, and a non-QoS Null frame, and wherein the second transmission includes an acknowledgement (ACK) frame that the second apparatus is configured to send in response to the first transmission.

110. The method of claim 109, wherein the second apparatus is required by a technical standard to send the ACK frame regardless of a basic service set identifier (BSSID) and a network allocation vector (NAV) setting of the network.

111. The method of claim 105, wherein the first transmission indicates a predefined globally-reserved address as a transmitter address, the predefined globally-reserved address being one that is specified by a technical standard or that has been rendered inoperable such that the predefined globally-reserved address is reserved for apparatuses performing the candidate address test.

112. The method of claim 105,
wherein the first transmission includes a receiver address field, a transmitter address field, and a test address field,
wherein the receiver address field indicates the first candidate network address,
wherein the transmitter address field indicates either the first candidate network address, a predefined globally-reserved address, a random address selected from the first locally administered address range, or a temporary address from a reserved address range, and
wherein the test address field indicates either the first candidate network address, the predefined globally-reserved address, the random address, or the temporary address.

113. The method of claim 105, further comprising:
performing a predetermined quantity of iterations of the candidate address test before using the first candidate network address as a locally administered MAC address of the first apparatus; and
using the first candidate network address as the locally administered MAC address of the first apparatus when the first apparatus does not receive any responses during any of the predetermined quantity of iterations of the candidate address test.

114. The method of claim 105, further comprising:
determine that the first apparatus has not monitored the communication medium during a period of absence that occurs after using the first candidate network address as the locally administered MAC address of the first apparatus, wherein the period of absence is associated with at least one member selected from a group consisting of a power save mode, a channel scanning operation, a discovery operation, and a channel switch; and
performing another iteration of the candidate address test before continuing to use the first candidate network address as the locally administered MAC address of the first apparatus.

115. The method of claim 105, further comprising, after performing the candidate address test and before using the first candidate network address as the locally administered MAC address of the first apparatus:
performing an extended address test to determine whether the first candidate network address is used by the second apparatus on another communication medium associated with a data link layer domain of the network, wherein the extended address test includes:
sending an association request to an access point (AP) of the network, the association request including the first candidate network address and an indicator that the first candidate network address is a new locally administered MAC address of the first apparatus; and
receiving an association response from the AP having an indicator to indicate whether the first candidate network address is available for the first apparatus to use in the network, wherein the indicator is based on at least one of results of a data link layer test performed by the AP and check of a database of locally administered addresses in use in the network.

116. The method of claim 105, further comprising:
determining, by the first apparatus, a second candidate network address from the first locally administered address range;
performing an iteration of the candidate address test using the second candidate network address to determine that no other apparatus is using the second candidate network address on the communication medium; and
using the first candidate network address as a primary address of the first apparatus and the second candidate network address as a secondary address of the first apparatus.

117. The method of claim 116, further comprising:
establishing an association with an access point of the network using the first candidate network address as the primary address of the first apparatus and the second candidate network address as the secondary address of the first apparatus.

118. The method of claim 117, wherein the first apparatus is capable of interchangeably using both the primary address and the secondary address for communication with the network, the method further comprising:
receiving a data transmission from the access point, wherein the data transmission includes a message integrity check (MIC) portion, and wherein the MIC portion is derived by the access point using either the primary address or the secondary address; and
verifying, by the first apparatus, an integrity of the data transmission using the MIC portion derived using either the primary address or the secondary address.

119. The method of claim 117, further comprising:
detecting that another apparatus is using the primary address for communication with the network;
discontinuing use of the primary address;
upgrading the secondary address to a new primary address;
determining a new candidate network address to use as a new secondary address; and
sending one or more messages to the access point having the secondary address as the new primary address, the one or more messages informing the access point of the new primary address and the new secondary address.

120. The method of claim 119, further comprising:
performing a fast session transfer (FST) procedure to upgrade the secondary address to the new primary address, wherein the FST procedure includes sending an FST message with a pre-arranged token established by the first apparatus and the access point as part of an FST session setup or secure message exchange.

121. The method of claim 120, wherein detecting that another apparatus is using the primary address for communication with the network includes:
receiving a notification from the access point that the access point has detected an address collision of the primary address, the notification including the pre-arranged token.

122. The method of claim 105, further comprising:
determining a list of candidate network addresses from the first locally administered address range including at the first candidate network address;
outputting a candidate address check request frame for transmission to an access point of the network, wherein the candidate address check request frame includes the list of candidate network addresses; and
receiving a candidate address check response frame from the access point indicating at least the first candidate network address selected by the access point from among the list of candidate network addresses.

123. The method of claim 122, wherein the candidate address check response frame from the access point includes those addresses from among the list of candidate network addresses that are not being used by any other apparatuses in a data link layer domain of the network.

124. The method of claim 105, wherein using the first candidate network address as the locally administered MAC address of the first apparatus includes using the first candidate network address a primary address of the first apparatus in a peer association between the primary address of the first apparatus and a peer address of a peer apparatus, the peer association including a tunneled direct link setup (TDLS) link administered by an access point of the network.

125. The method of claim 124, further comprising:
sending a TDLS Address Change Request frame to the peer apparatus to change the primary address of the first apparatus from the first candidate network address to a second candidate network address from at least the first locally administered address range.

126. The method of claim 125, wherein the TDLS Address Change Request frame is inserted in an Ethertype 89-0d frame. and wherein the TDLS Address Change Request frame includes a pre-arranged token established between the first apparatus and the peer apparatus during a peer setup of the peer association.

127. A method for network communication by an access point of a network comprising:
receiving a candidate address check request frame from a first apparatus, wherein the candidate address check request frame includes a list of candidate network addresses from at least a first locally administered address range; and
sending a candidate address check response frame from the access point to the first apparatus, the candidate address check response frame indicating at least a first candidate network address from among the list of candidate network addresses for the first apparatus to use on the network.

128. The method of claim 127, further comprising:
maintaining a database including a list of locally administered addresses used by apparatuses in the network; and
selecting the first candidate network address from among the list of candidate network addresses based on a determination that the first candidate network address is not used by apparatuses in the network.

129. The method of claim 127, further comprising:
for at least the first candidate network address:
performing, by the access point, a candidate address test to verify that no other apparatus is using the first candidate network address, wherein the candidate address test includes outputting a first transmission having the first candidate network address via a communication medium of the network, the first transmission being configured to instigate a second transmission from at least one other apparatus in the network as a response to the first transmission if the first candidate network address is being used by a second apparatus in the network, wherein the candidate address test further includes monitoring for the second transmission during a time period following the first transmission; and
determining that no other apparatus is using the first candidate network address on the communication medium when the access point does not detect the second transmission in the candidate address test.

130. The method of claim 129, further comprising:
performing an extended address test to determine whether the first candidate network address is used by another apparatus on within a data link layer domain associated with the network.

131. The method of claim 130, further comprising:
receiving an association request from the first apparatus using the first candidate network address, wherein the association request includes an indicator that first candidate network address is a new address of the first apparatus in the network, wherein the extended address test is performed in response to receiving the association request with the indicator; and
sending an association response to the first apparatus based, at least in part, on results of the extended address test performed by the access point.

132. The method of claim 131, wherein the association request includes the first candidate network address and further includes a second candidate network address from at least a first locally administered address range; and
establishing an association with the first apparatus using the first candidate network address as a primary address of the first apparatus and the second candidate network address as a secondary address of the first apparatus, wherein the first apparatus is capable of using interchangeably using both the primary address and the secondary address for communication with the network, and wherein the secondary address can be used if an address collision of the primary address is detected.

133. A first apparatus for use in a network, comprising:
an interface; and
a processor operatively coupled to the interface and configured to:
determine a first candidate network address from at least a first locally administered address range;
perform at least one iteration of a candidate address test that includes outputting a first transmission having the first candidate network address via a communication medium of a network, the first transmission being configured to instigate a second transmission from at least one other apparatus in the network as a response to the first transmission if the first candidate network address is being used by a second apparatus in the network, wherein the candidate address test further includes monitoring for the second transmission during a time period following the first transmission; and
cause the interface to use the first candidate network address as a locally administered media access control (MAC) address of the first apparatus when the first apparatus does not detect the second transmission in the candidate address test.

134. The first apparatus of claim 133, wherein the processor is further configured to:
determine that first candidate network address is being used by the second apparatus in the network;
determine a second candidate network address from the first locally administered address range;
perform a second iteration of the candidate address test using the second candidate network address instead of the first candidate network address; and
cause the interface to use the second candidate network address as the locally administered MAC address of the first apparatus when the first apparatus does not detect the second transmission in the second iteration of the candidate address test.
